(19) United States
(12) Patent Application Publication
(10) Pub. No.: US 2020/0065405 A1
(43) Pub. Date: Feb. 27, 2020

(54) Computer System & Method for Simplifying a Geospatial Dataset Representing an Operating Environment for Assets

(71) Applicant: Uptake Technologies, Inc., Chicago, IL (US)

(72) Inventors: Greg Gandenberger, Mt. Prospect, IL (US); Tyler Eilert Bruns, Highland Park, IL (US); Joseph Lee, Chicago, IL (US)

(21) Appl. No.: 16/109,611

(22) Filed: Aug. 22, 2018

(51) Int. Cl. G06F 17/30

(52) U.S. Cl. CPC G06F 17/30303; G07C 5/085; G06F 17/30958

(57) ABSTRACT

A computing system may be configured to simplify a complex dataset of nodes representing an operational environment. To that end, the computing system (a) associates nodes with a respective set of asset data related to how assets operate when located in proximity to the given node, where the respective asset data includes a respective value of at least one given asset-data variable, (b) evaluates whether any nodes can be eliminated using a divergence function that determines a maximum divergence between (i) one set of values including an original value of the given asset-data variable for each candidate node and (ii) another set of values including an imputed value of the given variable for each candidate node, (c) removes nodes from the dataset identified for elimination, thereby generating a reduced dataset, and (d) uses the reduced dataset to evaluate the operation of assets in the environment defined by the reduced dataset.

### BACKGROUND

Today, machines (also referred to herein as “assets”) are ubiquitous in many industries. From locomotives that transfer cargo across countries to farming equipment that harvest crops, assets play an important role in everyday life. Depending on the role that an asset serves, its complexity, and cost, may vary.

Because of the increasing role that assets play, it is also becoming increasingly desirable to monitor and analyze the operation of assets in a given operating environment. To facilitate this, assets may be equipped with components that are configured to monitor various operating parameters of the asset and then send data indicative of these operating parameters to a data analytics platform that is configured to analyze the data, in order to learn more about the operation of the assets.

### OVERVIEW

In general, a data analytics platform may be configured to perform various computing tasks to facilitate monitoring, analyzing, and/or making predictions about the operation of assets in a real-world operating environment, such as a rail network, a construction or mining site, etc., and many of these computing tasks may be compute intensive (e.g., in terms of the processing and/or storage resources required to carry out these tasks, the time it takes to carry out these tasks, etc.). As one example, the data analytics platform may be configured to monitor and/or analyze the real-world movement of an asset in an operating environment, which may involve various compute-intensive tasks. In another example, the data analytics platform may be configured to create and execute a computer simulation of asset operation in an operating environment, which may involve various compute-intensive tasks. In yet another example, the data analytics platform may be configured to perform data analytics on images of an operating environment in which assets operate, which may involve various compute-intensive tasks. In order to facilitate monitoring, analyzing, and/or making predictions about the operation of assets in a real-world operating environment, a data analytics platform may be configured to perform various other compute-intensive tasks as well.

In practice, a data analytics platform may be configured to perform computing tasks such as those described above for a large number of assets, which may compound the compute-intensive nature of the computing tasks performed by the data analytics platform. Indeed, as the number of assets increases, the number of compute-intensive tasks performed by the platform, the volume of data that is used to carry out these tasks, and/or the complexity of these tasks may likewise increase.

Further, in practice, computing tasks such as those described above may also involve an analysis of certain types of environmental data associated with an environment in which assets are operating, including geospatial data that defines the operating environment. As a brief background, a geospatial dataset generally comprises a set of “nodes” (also referred to as “points”), “linestrings” (also referred to as “ways” or “polylines”), and “polygons.” A node generally represents a point-type feature in a geographic environment, such as a particular latitude, longitude, and altitude position. Two or more interconnected nodes define a linestring, which generally represents a line-type feature in a geographic environment, such as a road, railway, river, power line, etc. A linestring can be composed to form a polygon, which generally represents an area-type feature in a geographic environment, such as a building, park, etc. Other aspects of a geospatial dataset may also exist, some of which are discussed below.

In order to promote an accurate representation of the operating environment, a geospatial dataset typically comprises a large number of nodes, which further compounds the compute-intensive nature of the computing tasks performed by the data analytics platform. Indeed, it will be appreciated that a geospatial dataset having a greater number of nodes will generally provide a more accurate representation of an operating environment than a geospatial dataset having fewer number of nodes. However, in line with the above discussion, a geospatial dataset that uses a greater number of nodes to represent an environment will generally impose a greater burden on a data analytics platform's ability to carry out computing tasks based on that geospatial dataset, both in terms of the processing and/or storage resources required to carry out such computing tasks and the time it takes to carry out such computing tasks.

Thus, in order to carry out compute-intensive tasks such as those described above, a data analytics platform may need to expend a significant amount of its processing and/or storage resources, which may impact the platform's ability to perform other tasks. Likewise, in order to carry out compute-intensive tasks such as those described above, a data analytics platform may need to be equipped with particular hardware or the like to facilitate performing these tasks, such as processing components that provide high computational speeds and/or a large amount of data storage, which may limit the universe of data analytics platforms that are even capable of carrying out these compute-intensive tasks.

For at least these reasons, there is a need for technology that operates to simplify a geospatial dataset (or some other complex dataset) by eliminating data points without significantly degrading the fidelity of the dataset.

One existing technique that attempts to address this need is the Douglas-Peucker algorithm, which determines whether a node of a linestring, polygon, or some other geospatial data object is “non-critical” and can thus be eliminated based on an evaluation of geospatial distance. For instance, the Douglas-Peucker algorithm involves determining if removing a node from a linestring will result in a modified linestring that is not too far in distance from the original linestring. If the determination is affirmative, then that node is deemed “non-critical” and can be eliminated from the geospatial dataset; otherwise, the node is kept. However, because the Douglas-Peucker algorithm identifies and eliminates “non-critical” nodes from a geospatial dataset based exclusively on geospatial distance, it is not suitable for all applications. Indeed, in certain applications, the definition of whether a node is “critical” or “non-critical” may depend on factors other than geospatial distance.

To illustrate, consider an application that is designed to simulate asset operation within an operating environment. In such an application, there may be certain nodes within the operating environment that are particularly relevant to how the assets operate in the environment, such as a node within the operating environment where there is a meaningful change in asset operation. For example, in the context of a rail network, there could be a node along a railway where there is often a meaningful change in the speed of the locomotives, the fuel level of the locomotives, etc., in which case the node should be kept in the geospatial dataset that is used to simulate asset operation regardless of whether that node would be deemed “non-critical” under the Douglas-Peucker algorithm. As such, there remains a need for technology that operates to simplify a complex dataset, such as a geospatial dataset, based on factors other than geospatial distance.

To help address one or more of the foregoing issues, disclosed herein is an innovative process for simplifying a geospatial dataset (or some other complex dataset) that is to be used by a data analytics system while performing certain computing tasks. Advantageously, the disclosed simplification process may help to reduce the computing resources required to perform these computing tasks, which may in turn improve the overall operation of the data analytics platform. In this way, the disclosed simplification process may provide a technological solution to the technological problems that arise in the context of data analytics platforms performing complex computing tasks.

According to one example embodiment of the disclosed simplification process, the data analytics platform may begin by identifying for evaluation an initial set of geospatial data that represents a particular operating environment for assets, where the initial geospatial dataset includes one or more linestrings that each include multiple nodes. In practice, the one or more linestrings themselves may be one or more geospatial data objects (i.e., one or more individual linestrings) or may be part of a geospatial data object, such as a polygon. In operation, the data analytics platform may identify the initial geospatial dataset in a variety of manners.

As one possibility, the data analytics platform may identify the initial dataset based on inputs received by a client station or the like that is communicatively coupled with the data analytics platform. For example, a user might operate, via a client station, a front-end application provided by the data analytics platform and submit inputs indicating a selection of a particular operating environment of interest. The client station may then send to the data analytics platform data indicative of the selected operating environment, from which the data analytics platform can identify the initial geospatial dataset corresponding to that environment.

As another possibility, the data analytics platform may identify the initial dataset based on an identification of one or more assets of interest. For example, through enterprise data for a given organization, the data analytics platform may identify the particular assets owned and/or operated by the given organization, and then, the data analytics platform may identify historical, present, and/or future route schedules, operational plans, or the like for the identified assets. The data analytics platform may then identify geospatial data corresponding to an operating environment that is implicated by such asset route schedules, operational plans, or the like.

As yet another possibility, the data analytics platform may identify the initial dataset based on certain predetermined criteria, such as temporal and/or dataset size criterion. For example, the data analytics platform may be configured to identify geospatial data corresponding to any operating environment that certain assets traversed or otherwise operated in within the past seven days, the past month, etc., or to identify a predetermined amount of geospatial data. Other examples of identifying the initial geospatial dataset are also possible.

After the data analytics platform identifies the initial geospatial dataset, the data analytics platform may next associate each of at least a subset of the nodes within the initial geospatial dataset with a respective set of data that is related to how assets typically operate when located in proximity to the node, which may generally be referred to herein as the node's “asset dataset.”

In practice, the associated asset dataset for a node may comprise a respective value for each of one or more asset data variables. In this respect, the one or more asset data variables that make up a node's asset dataset may take various forms. As one example, the one or more asset data variables that make up a node's asset data may include one or more operating data variables for assets located in proximity to the node, examples of which may include a data variable indicating a typical speed of assets located in proximity to that node, a data variable indicating a typical fuel level of assets located in proximity to the node, etc. As another example, the one or more asset data variables that make up a node's asset dataset may include one or more weather data variables that have a bearing on the operation of assets located in proximity to the node, examples of which may include a data variable indicating a typical ambient temperature in proximity to the node, a data variable indicating a typical humidity in proximity to the node, etc. Other examples are possible as well.

Further, the respective value for each asset data variable may take a variety of forms. As one example, an asset data variable's respective value may take the form of a discrete data value that is derived from the individual data values captured for the asset data variable, such as an average of the individual speed values captured for assets located in proximity to a node. In another example, an asset data variable's respective value may take the form of a probability or frequency distribution of the individual data values captured for the asset data variable, such as a distribution of the individual speed values captured for assets located in proximity to a node. In yet another example, an asset data variable's respective value may take the form of one or more time-dependent data values (or a distribution of values) that are derived from the individual data values captured for the asset data variable, which may be specific to a particular time of day, a particular time of year, or the like. Other examples are also possible.

Further yet, the respective set of possible values for each asset data variable could take any of a variety of styles, examples of which may include numerical values (e.g., 50° Fahrenheit), ordinal values (e.g., a value indicating temperature on a 1-5 scale), categorical values (e.g., “frozen,” “cold,” “neutral,” “hot,” “boiling”), or the like. In this respect, to the extent that a given asset data variable has a non-numerical value, the data analytics platform may also be configured to convert that non-numerical value into a numerical value for subsequent functions in the simplification process.

Still further, the data analytics platform may associate a node with an asset dataset in various manners. As one possibility, the data analytics platform may perform this association on a node-by-node basis, in which case the data analytics platform may assign each of a plurality of nodes its own node-specific asset dataset. As another possibility, the data analytics platform may perform this association for a larger geospatial area that contains multiple nodes, in which case the data analytics platform may then assign the asset dataset for the larger geospatial area to each node located in that area. The data analytics platform may associate a node with an asset dataset in other manners as well.

Once the data analytics platform has associated the plurality of nodes from the initial geospatial dataset with asset data that is related to how assets typically operate when located in proximity to those nodes, the data analytics platform may use this asset data as a basis to identify “non-critical” nodes that can be eliminated from the geospatial dataset. The data analytics platform may perform this function in a variety of manners.

According to one possible approach, the data analytics platform may identify “non-critical” nodes that can be eliminated from the initial geospatial dataset by evaluating one or more linestrings included in the geospatial dataset using a divergence function that is based on at least one given asset data variable related to how assets operate when located in proximity to the nodes (e.g., asset speed, asset fuel level, ambient temperature, etc.). The data analytics platform may carry out this operation in various manners.

In one example implementation, the data analytics platform may begin by selecting a linestring from the initial geospatial dataset that is to be evaluated for node reduction. For purposes of this disclosure, a linestring selected for evaluation may be referred to as a “candidate” linestring. In practice, this candidate linestring may be selected in various manners.

As one possibility, the data analytics platform may select the candidate linestring based on inputs received by a client station or the like that is communicatively coupled with the data analytics platform. For example, a user might operate, via a client station, a front-end application provided by the data analytics platform and submit inputs indicating a selection of a particular line-type feature within the operating environment that is of interest. The client station may then send to the data analytics platform data indicative of the selected line-type feature, from which the data analytics platform can identify a linestring corresponding to that line-type feature and designate that linestring the candidate linestring.

As another possibility, the data analytics platform may select the candidate linestring based on certain predetermined criteria, such as a threshold number of nodes. For instance, the data analytics platform may identify any linestrings in the initial geospatial dataset that include, for example, more than two nodes. The data analytics platform may then designate one of those identified linestrings as the candidate linestring. The data analytics platform may select the candidate linestring in other manners as well.

Once the candidate linestring has been selected, the data analytics platform may identify at least two nodes in the candidate linestring that are to be used to impute a value of the given asset data variable for each other node in the linestring that is to be evaluated for elimination. In this respect, the identified at least two nodes may be referred to herein as “imputation nodes” for the candidate linestring and the one or more other nodes in the linestring that are to be evaluated for elimination may be referred to herein as the “candidate nodes” for the candidate linestring.

The imputation nodes can be identified in a variety of manners. As one possibility, the data analytics platform may identify the endpoint nodes of the candidate linestring (e.g., the nodes corresponding to the start and end of the linestring) as the imputation nodes for the candidate linestring. As another possibility, the data analytics platform may designate at least one node that has been previously designated for retainment—which may have been so designated based on a prior iteration of this operation—as one of the imputation nodes for the candidate linestring. Other examples of identifying the imputation nodes are also possible.

After identifying the imputation nodes, the data analytics platform may then use the imputation nodes' respective values of the given asset data variable to assign a respective imputed value of the given asset data variable to each candidate node of the candidate linestring (e.g., each intermediate node of the candidate linestring), where the respective imputed value of the given asset data variable for a given candidate node represents a value of the given asset data variable at the given candidate node's location along the candidate linestring in a scenario where the candidate node is eliminated. The data analytics platform may carry out this operation in various manners.

As one possibility, the data analytics platform may use the imputation nodes' respective values of the given asset data variable to determine a single imputed value of the given asset data variable for the candidate linestring and then assign that single imputed value to each candidate node in the candidate linestring. In this respect, as one example, the single imputed value may be an average of the imputation nodes' respective values of the given asset data variable. The single imputed value may take other forms and be determined in other manners as well.

As another possibility, the data analytics platform may use the imputation nodes' respective values of the given asset data variable to perform a node-by-node determination of an imputed value of the given asset data variable for each candidate node, such that each candidate node is assigned its own imputed value. For instance, based on the imputation nodes' respective values of the given asset data variable and a candidate node's relative location within the candidate linestring, the data analytics platform may interpolate an imputed value of the given asset data variable for the candidate node. The data analytics platform may use the imputation nodes' respective values of the given asset data variable to assign a respective imputed value of the given asset data variable to each candidate node of the candidate linestring in other manners as well.

As a result of the data analytics platform assigning a respective imputed value of the given asset data variable to each candidate node of the candidate linestring, the candidate linestring will then have two sets of values of the given asset data variable: (i) a first set that includes each candidate node's respective original value of the given asset data variable and (ii) a second set that includes each candidate node's respective imputed value of the given asset data variable.

The data analytics platform may then input these two sets of values into a divergence function, which may in turn determine and output a maximum divergence between the original and imputed values of the given asset data variable. In practice, the divergence function may make this determination by calculating a respective divergence between the original and imputed values of the given asset data variable for each candidate node and then identifying the largest of these respective divergences. However, the divergence function may determine the maximum divergence between the original and imputed values of the given asset data variable in other manners as well.

Once the maximum divergence between the original and imputed values of the given asset data variable has been determined, the data analytics platform may compare the maximum divergence to a threshold that serves as a dividing line between a loss of fidelity for the given asset data variable that is acceptable and a loss of fidelity for the given asset data variable that is not acceptable. Based on this comparison, the data analytics platform may determine either (i) that the maximum divergence is at or below the threshold, in which case elimination of all candidate nodes in the candidate linestring would result in a loss of fidelity for the given asset data variable that is acceptable or (ii) that the maximum divergence exceeds the threshold, in which case elimination of all candidate nodes in the candidate linestring would result in a loss of fidelity for the given asset data variable that is not acceptable.

If the maximum divergence is at or below the threshold, the data analytics platform may designate each candidate node in the linestring as a “non-critical” node that can be eliminated, while the imputation nodes of the candidate linestring (e.g., the endpoint nodes) are to be retained. At that point, the data analytics platform may consider the evaluation to be completed for the current candidate linestring and may select another candidate linestring in the geospatial dataset to evaluate (to the extent there are other linestrings in the geospatial dataset that are still eligible for evaluation).

On the other hand, if the maximum divergence exceeds the threshold—which indicates that elimination of all candidate nodes in the candidate linestring would result in an unacceptable loss of fidelity for the given asset data variable—the data analytics platform may evaluate whether less than all candidate nodes in the candidate linestring can be eliminated. The data analytics platform may carry out this evaluation in various manners. As one possible example, the data analytics platform may (i) identify the node in the candidate linestring that is associated with the maximum divergence, (ii) break the candidate linestring into two segments that intersect at the identified node (in which case the identified node becomes an endpoint for the two segments), (iii) for a segment that only has two nodes, determine that no nodes can be eliminated, and (iv) for a segment that has more than two nodes, recursively perform the foregoing process to evaluate whether any node(s) in the segment can be eliminated. Once this evaluation has been completed, the data analytics platform may then select another candidate linestring in the geospatial dataset to evaluate (to the extent there are other linestrings in the geospatial dataset that are still eligible for evaluation).

As a result of evaluating one or more of the linestrings in the geospatial dataset using the foregoing process, the data analytics platform may have identified a set of “non-critical” nodes in the initial geospatial dataset that have been designated for elimination. In turn, the data analytics platform may use the identified set of “non-critical” nodes as a basis for generating a reduced geospatial dataset.

For instance, in one implementation, the data analytics platform may be configured to eliminate every node in the identified set of “non-critical” nodes from the initial geospatial dataset. However, in other implementations, the data analytics platform may be configured to eliminate less than every node in the identified set of “non-critical” nodes from the initial geospatial dataset. In this respect, the data analytics platform may select which “non-critical” nodes to retain in various manners.

As one possibility, the data analytics platform may be configured to generate and maintain a “whitelist” of nodes in the initial geospatial dataset that are ineligible for elimination regardless of whether such nodes have been designated as “non-critical” using the operation described above, in which case the data analytics platform may use this “whitelist” as the basis for selecting certain nodes within the identified set of “non-critical” nodes that should not be eliminated. In this respect, the function of identifying nodes in the initial geospatial dataset to include on the “whitelist” may take various forms. As one possible example, this function may involve identifying each node in the initial geospatial dataset having an associated asset dataset that satisfies certain “whitelist” threshold criteria, which may be directed to one or more asset data variables within the node's asset dataset (e.g., asset speed, asset fuel level, ambient temperature, etc.). Depending on how the value of each such asset data variable is represented, the threshold criteria may take any of various forms. The function of identifying nodes in the initial geospatial dataset to include on the “whitelist” may take other forms as well.

In still other implementations, it is possible that the data analytics platform may generate and use such a “whitelist” as a means for pre-processing the initial geospatial dataset before the aforementioned operation for identifying “non-critical” nodes is performed. For example, before identifying “non-critical” nodes in the initial geospatial dataset using a divergence function, the data analytics platform may (i) identify linestrings in the initial geospatial dataset having intermediate nodes that appear on the “whitelist” and then (ii) divide each such linestring into two segments that intersect at the “whitelist” node, which may be subsequently treated as separate linestrings during the elimination operation. In practice, this approach of using a “whitelist” to pre-process the initial geospatial dataset before identifying “non-critical” nodes using a divergence function may be more preferable than using a “whitelist” to retain nodes from the identified set of “non-critical” nodes after identifying “non-critical” nodes using a divergence function, because it may provide for a more efficient use of the data analytics platform's computing resources.

There may be other ways to use a “whitelist” in conjunction with the function of identifying “non-critical” nodes using a divergence function as well.

In any event, after the data analytics platform uses the identified set of “non-critical” nodes as a basis for generating a reduced geospatial dataset, the data analytics platform may use this reduced geospatial dataset to perform certain computing tasks in a more efficient manner than if it were performing those computing tasks using the initial geospatial dataset. For instance, in line with the above discussion, the reduced geospatial dataset may enable the data analytics platform to expend fewer compute resources than if it were using the initial geospatial dataset and may also help to reduce data storage requirements of the data analytics platform and/or computational strain on the data analytics platform.

As noted above, some example computing tasks that the data analytics platform may be able to perform more efficiently with the reduced geospatial dataset may include creating and/or executing computer simulations of asset operation in an operating environment defined by the reduced geospatial dataset, performing image analytics for an operating environment defined by the reduced geospatial dataset, and monitoring the real-world movement of an asset through an operating environment represented by the reduced geospatial dataset, among other examples.

Moreover, the disclosed simplification process may provide various other advantages as well. As one possibility, the data analytics platform may output recommendations regarding placement and/or maintenance of asset-environment sensors based the results of the disclosed simplification process. For instance, the disclosed simplification process can be used to identify “critical” locations in an operating environment at which asset-environment sensors (e.g., wayside sensors on a railway) should be placed. On the other hand, the disclosed simplification process can be used to identify “non-critical” locations in an operating environment at which previously placed asset-environment sensors can be removed or allowed to fall out of service.

As another possibility, a local analytics device of an asset may be configured to apply the simplification process to geospatial data that is being captured “on the fly” by assets as they move through an operating environment, which may help to reduce the compute resources necessary to process and store such a geospatial dataset at the asset as well as the network resources required to transmit such a geospatial dataset from the asset to another data analytics platform.

The disclosed simplification process may provide other advantages and/or enable other functions as well.

Accordingly, in one aspect, disclosed herein is a method that involves (a) identifying an initial dataset that is representative of a given environment in which assets operate, wherein the initial dataset comprises a plurality of linestrings each having at least two nodes, (b) associating each of a plurality of nodes with a respective set of asset data that is related to how assets operate when located in proximity to the node, wherein the respective set of asset data for each of the plurality of nodes comprises a respective value of at least one given asset data variable, (c) for each of one or more candidate linestrings in the initial dataset, evaluating whether any one or more candidate nodes in the candidate linestring can be eliminated using a divergence function that operates to determine a maximum divergence between (i) one set of values that includes an original value of the given asset data variable for each of the one or more candidate nodes and (ii) another set of values that includes an imputed value of the given asset data variable for each of the one or more candidate nodes, (d) based on the evaluation, identifying a set of nodes in the initial dataset that can be eliminated, (e) using the identified set of nodes as a basis to eliminate one or more nodes from the initial dataset and thereby generate a reduced dataset, and (f) using the reduced dataset to evaluate the operation of assets in the given environment.

In another aspect, disclosed herein is a computing system that comprises at least one processor, a non-transitory computer-readable medium, and program instructions stored on the non-transitory computer-readable medium that are executable by the at least one processor to cause the computing system to carry out the functions disclosed herein, including but not limited to the functions of the foregoing method.

In yet another aspect, disclosed herein is a non-transitory computer-readable medium comprising program instructions that are executable to cause a computing system to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts a simplified block diagram of an example asset data platform from a structural perspective.

FIG. 3 depicts a simplified block diagram of an example asset data platform from a functional perspective.

FIG. 4 depicts a simplified block diagram of the on-board components of an example asset.

FIG. 5 depicts a simplified block diagram of an example local analytics device.

FIG. 6 depicts a flow diagram for an example simplification process.

FIG. 7A depicts a conceptual illustration of a geospatial dataset representing a particular geographic environment.

FIG. 7B depicts a conceptual illustration of an initial geospatial dataset representing a particular operating environment

FIG. 7C depicts a conceptual illustration of a reduced geospatial dataset representing a simplified operating environment.

FIG. 8 depicts a conceptual illustration of nodes of an initial geospatial dataset that have been associated with asset data.

FIG. 9A depicts a conceptual illustration of certain aspects of functions related to assigning respective imputed values of a given asset data variable to candidate nodes.

FIG. 9B provides a conceptual illustration of certain aspects of functions related to executing a divergence function.

FIG. 9C provides a conceptual illustration of certain aspects of the iterative process for evaluating an example candidate linestring.

FIG. 9D provides a conceptual illustration of certain aspects of the iterative process for evaluating an example candidate linestring.

FIG. 9E provides a conceptual illustration of certain aspects of the iterative process for evaluating an example candidate linestring.

FIG. 9F provides a conceptual illustration of certain aspects of the iterative process for evaluating an example candidate linestring.

FIG. 9G provides a conceptual illustration of certain aspects of the iterative process for evaluating an example candidate linestring.

FIG. 9H provides a conceptual illustration of certain aspects of the iterative process for evaluating an example candidate linestring.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. EXAMPLE NETWORK CONFIGURATION

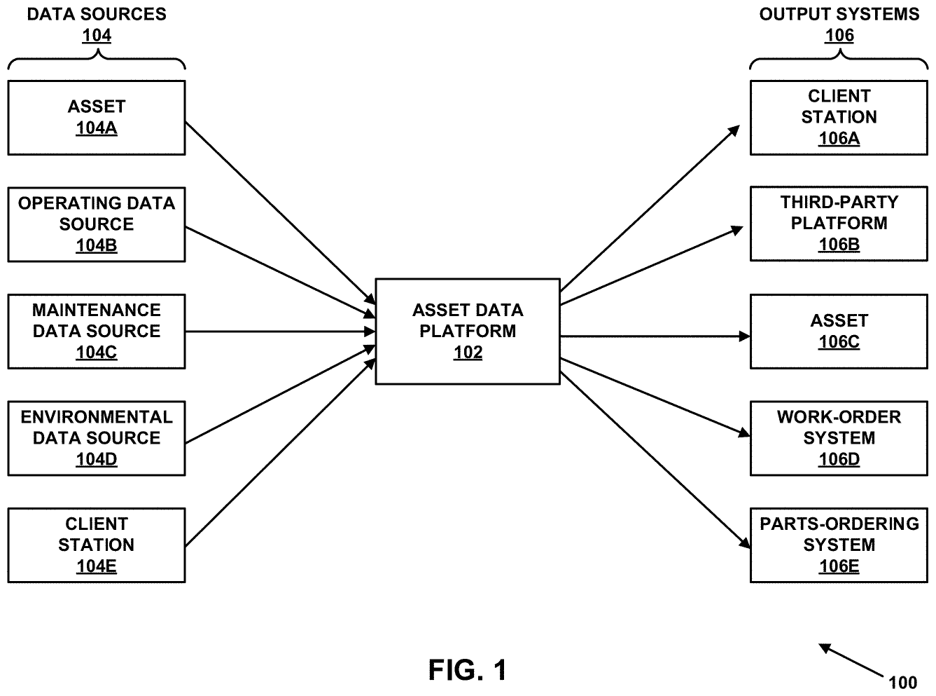

Turning now to the figures, FIG. 1 depicts an example network configuration 100 in which example embodiments may be implemented. As shown, network configuration 100 includes at its core a central computing system 102, which may be communicatively coupled to one or more data sources 104 and one or more output systems 106 via respective communication paths. In such an arrangement, central computing system 102 may generally serve as an “asset data platform” that is configured to perform functions to facilitate the monitoring, analysis, and/or management of various types of “assets,” which may take various forms.

For instance, some representative types of assets that may be monitored by asset data platform 102 may include transport vehicles (e.g., locomotives, aircrafts, passenger vehicles, trucks, ships, etc.), equipment for construction, mining, farming, or the like (e.g., excavators, bulldozers, dump trucks, earth movers, etc.), manufacturing equipment (e.g., robotics devices, conveyor systems, and/or other assembly-line machines), electric power generation equipment (e.g., wind turbines, gas turbines, coal boilers), petroleum production equipment (e.g., gas compressors, distillation columns, pipelines), and data network nodes (e.g., personal computers, routers, bridges, gateways, switches, etc.), among other examples. Additionally, an asset may have various other characteristics that more specifically define the type of asset, examples of which may include the asset's brand, make, model, vintage, and/or software version, among other possibilities. In this respect, depending on the implementation, the assets monitored by asset data platform 102 may either be of the same type or various different types. Additionally yet, the assets monitored by asset data platform 102 may be arranged into one or more “fleets” of assets, which refers to any group or two or more assets that are related to one another in some manner (regardless of whether such assets are of the same type).

Broadly speaking, asset data platform 102 may comprise one or more computing systems that have been provisioned with software for carrying out one or more of the platform functions disclosed herein, including but not limited to receiving data related to the operation and/or management of assets (broadly referred to herein as “asset-related data”) from data sources 104, performing data ingestion and/or data analytics operations on the asset-related data received from asset data sources 104, and then outputting data and/or instructions related to the operation and/or management of assets to output systems 106. The one or more computing systems of asset data platform 102 may take various forms and be arranged in various manners.

For instance, as one possibility, asset data platform 102 may comprise computing infrastructure of a public, private, and/or hybrid cloud (e.g., computing and/or storage clusters) that has been provisioned with software for carrying out one or more of the platform functions disclosed herein. In this respect, the entity that owns and operates asset data platform 102 may either supply its own cloud infrastructure or may obtain the cloud infrastructure from a third-party provider of “on demand” computing resources, such as Amazon Web Services (AWS), Microsoft Azure, Google Cloud, Alibaba Cloud, or the like. As another possibility, asset data platform 102 may comprise one or more dedicated servers that have been provisioned with software for carrying out one or more of the platform functions disclosed herein. Other implementations of asset data platform 102 are possible as well.

Further, in practice, the software for carrying out the disclosed platform functions may take various forms. As one possibility, the platform software may comprise executable program instructions that cause asset data platform 102 to perform data ingestion operations on asset-related data received from data sources 104, including but not limited to extraction, transformation, and loading operations, among other examples. As another possibility, the platform software may comprise executable program instructions that cause asset data platform 102 to perform data analytics operations based on the asset-related data received from data sources 104, including but not limited to failure prediction, anomaly detection, fuel management, noise filtering, image analysis, predictive recommendations, and label correction, among other examples. As yet another possibility, the platform software may comprise executable program instructions that cause asset data platform 102 to output data and/or instructions related to the operation and/or management of assets for receipt by one or more output systems 106.

As one specific example, the platform software may comprise executable program instructions for outputting data related to the operation and/or management of assets that is to be presented to a user (e.g., asset-related data received from data sources 104 and/or the results of the data analytics operations performed by asset data platform 102), and these program instructions may take the form of discrete “applications” that are each tailored for particular end users, particular groups of assets, and/or particular purposes. Some representative examples of such applications may include an asset performance management application, an asset fleet management application, a service optimization application, and an asset dealer operations application, among other possibilities.

The software for carrying out the disclosed platform functions may take various other forms as well.

As described above, asset data platform 102 may be configured to receive asset-related data from one or more data sources 104. These data sources—and the asset-related data output by such data sources—may take various forms. To illustrate, FIG. 1 shows some representative examples of data sources 104 that may provide asset-related data to asset data platform 102, which are discussed in further detail below. However, it should be understood that these example data sources are merely provided for purposes of illustration, and that asset data platform 102 may be configured to receive asset-related data from other types of data sources as well.

For instance, one type of data source 104 may take the form of an asset 104A, which may be equipped with components that are configured to capture data that is indicative of the operation of the asset—referred to herein as “operating data”—and then transmit the asset's operating data to asset data platform 102 over the respective communication path between asset 104A and asset data platform 102. In this respect, asset 104A may take any of the various forms described above, including but not limited to a transport vehicle, heavy equipment, manufacturing equipment, electric power generation equipment, and/or petroleum production equipment, among other types of assets. Further, it should be understood that the components of asset 104A for capturing and transmitting the asset's operating data either may be included as part of asset 104A as manufactured or may be affixed to asset 104A at some later date, among other possibilities.

The operating data that is captured and sent by asset 104A may take various forms. As one possibility, an asset's operating data may include sensor data that comprises time-series measurements for certain operating parameters of the asset, examples of which may include speed, velocity, acceleration, location, weight, temperature, pressure, friction, vibration, power usage, throttle position, fluid usage, fluid level, voltage, current, magnetic field, electric field, presence or absence of objects, current position of a component, and power generation, among many others. As another possibility, an asset's operating data may include abnormal-conditions data that indicates occurrences of discrete abnormal conditions at the asset, examples of which include fault codes that indicate the occurrence of certain faults at the asset (e.g., when an operating parameter exceeds a threshold), asset shutdown indicators, and/or other types of abnormal-condition indicators. As yet another possibility, an asset's operating data may include data that has been derived from the asset's sensor data and/or abnormal-conditions data, examples of which may include “roll-up” data (e.g., an average, mean, median, etc. of the raw measurements for an operating parameter over a given time window) and “features” data (e.g., data values that are derived based on the raw measurements of two or more of the asset's operating parameters). An asset's operating data may take various other forms as well.

In practice, an asset's operating data may also include or be associated with data that identifies the origin of the operating data. This origin data may take various forms. For example, such origin data may include identifying information for the originating asset (e.g., an asset ID and/or data indicating the asset's type, brand, make, model, age, software version, etc.) and/or identifying information for the component of asset 104A that captured the operating data (e.g., a sensor ID), among other possibilities. As another example, such origin data may include data indicating the time at which the operating data was captured (e.g., a timestamp) and/or the asset's location when the operating data was captured (e.g., GPS coordinates), to the extent that such location is not otherwise included in the operating data. Asset data platform 102 may receive other types of data from asset 104A as well.

Further, asset data platform 102 may be configured to receive operating data from asset 104A in various manners. As one possibility, asset 104A may be configured to send its operating data to asset data platform 102 in a batch fashion, in which case asset data platform 102 may receive periodic transmissions of operating data from asset 104A (e.g., on an hourly, daily, or weekly basis). As another possibility, asset data platform 102 may receive operating data from asset 104A in a streaming fashion as such operating data is captured by asset 104A. As yet another possibility, asset data platform 102 may receive operating data from asset 104A in response to sending a request for such data to asset 104A, in which case asset data platform 102 may be configured to periodically send requests for operating data to asset 104A. Asset data platform 102 may be configured to receive operating data from asset 104A in other manners as well.

Another type of data source 104 may take the form of operating data source 104B, which may comprise a computing system that is configured to receive operating data from one or more upstream sources of operating data (e.g., assets) and then provide this operating data to asset data platform 102 over the respective communication path between operating data source 104B and asset data platform 102. Such an operating data source may take various forms. As one possibility, operating data source 104B may comprise an existing data platform of a third-party organization that receives and/or maintains operating data for one or more assets, such as a data platform operated by an asset owner, an asset dealer, an asset manufacturer, an asset repair shop, or the like. As another possibility, operating data source 104B may comprise an intermediary system that compiles operating data from a plurality of upstream sources of operating data and then provides that compiled operating data to asset data platform 102. For example, such an intermediary system may take the form of a computing system located in proximity to a fleet of assets (e.g., at a job site or wind farm) that is configured to compile operating data for the fleet of assets or a computing system that is configured to compile operating data maintained by several third-party data platforms, among other possibilities. Operating data source 104B may take other forms as well.

The operating data that is maintained and sent by operating data source 104B may take various forms, including but not limited to any of the forms described above. In addition to the operating data received from the one or more upstream sources, the operating data provided by operating data source 104B may also include additional operating data that is generated by operating data source 104B itself, such as operating data that operating data sources 104B derives based on the operating data received from the one or more upstream sources (e.g., abnormal-conditions data, roll-up data, features data, etc.).

Further, as with asset 104A, asset data platform 102 may be configured to receive operating data from operating data source 104B in various manners. As one possibility, operating data source 104B may be configured to send its operating data to asset data platform 102 in a batch fashion, in which case asset data platform 102 may receive periodic transmissions of operating data from operating data source 104B (e.g., on an hourly, daily, or weekly basis). As another possibility, asset data platform 102 may receive operating data from operating data source 104B in a streaming fashion as such operating data is received and/or otherwise generated by operating data source 104B. As yet another possibility, asset data platform 102 may receive operating data from operating data source 104B in response to sending a request for such data to operating data source 104B, in which case asset data platform 102 may be configured to periodically send requests for operating data to operating data source 104B. As still another possibility, asset data platform 102 may receive operating data from operating data source 104B by accessing an Application Programming Interface (API) that has been made available by operating data source 104B, subscribing to a service provided by operating data source 104B, or the like. Asset data platform 102 may be configured to receive operating data from operating data source 104B in other manners as well.

Yet another type of data source 104 may take the form of an asset maintenance data source 104C, which may comprise a computing system that is configured to generate and/or receive data related to the maintenance of a plurality of assets—referred to herein as “maintenance data”—and then send this maintenance data to asset data platform 102 over the respective communication path between asset maintenance data source 104C and asset data platform 102. In this respect, asset maintenance data source 104C may take various forms. As one possibility, asset maintenance data source 104C may comprise an existing data platform of a third-party organization that is interested in tracking the maintenance of assets, such as an asset owner, asset dealer, asset manufacturer, asset repair shop, or the like. As another possibility, asset maintenance data source 104C may comprise an intermediary system that compiles asset maintenance data from multiple upstream sources (e.g., multiple repair shops) and then provides that compiled maintenance data to asset data platform 102. Asset maintenance data source 104C may take other forms as well.

The asset maintenance data that is maintained and sent by asset maintenance data source 104C may take various forms. As one example, the asset maintenance data may include details regarding inspections, maintenance, servicing, and/or repairs that have been performed or are scheduled to be performed on assets (e.g., work order data). As another example, the asset maintenance data may include details regarding known occurrences of failures at assets (e.g., date of failure occurrence, type of failure occurrence, etc.). Other examples are possible as well. As with the operating data, the asset maintenance data may also include or be associated with data indicating the origins of the asset maintenance data (e.g., source identifier, timestamp, etc.).

Further, asset data platform 102 may be configured to receive operating data from asset maintenance data source 104C in various manners, including but not limited to any of the manners discussed above with respect to operating data source 104B.

Still another type of data source 104 may take the form of environmental data source 104D, which may comprise a computing system that is configured to generate and/or receive data about an environment in which assets operate—referred to herein as “environmental data”—and then send this data to asset data platform 102 over the respective communication path between environmental data source 104D and asset data platform 102. In this respect, environmental data source 104D—and the environmental data provided thereby—may take various forms.

As one possibility, environmental data source 104D may take the form of a weather data source that provides information regarding the weather at locations where assets operate (e.g., ambient temperature, air pressure, humidity, wind direction, wind speed, etc.). As another possibility, environmental data source 104D may take the form of a geospatial data source that provides information regarding the geography and/or topology at locations where assets operate. As yet another possibility, environmental data source 104D may take the form of a satellite image data source that provides satellite imagery for locations where assets operate. As still another possibility, environmental data source 104D may take the form of a traffic data source that provides information regarding ground, air, and/or water traffic at locations where assets operate. Environmental data source 104D may take other forms as well.

Further, in practice, asset data platform 102 may be configured to receive operating data from asset environmental data source 104D in various manners, including but not limited to any of the manners discussed above with respect to operating data source 104B.

Another type of data source 104 may take the form of client station 104E, which may comprise any computing device that is configured to receive user input related to the operation and/or management of assets (e.g., information entered by a fleet operator, a repair technician, or the like) and then send that user input to asset data platform 102 over the respective communication path between client station 104E and asset data platform 102. In this respect, client station 104E may take any of various forms, examples of which may include a desktop computer, a laptop, a netbook, a tablet, a smartphone, and/or a personal digital assistant (PDA), among other possibilities.

The user input that is entered into client station 104E and sent to asset data platform 102 may comprise various different kinds of information, including but not limited to the kinds of information discussed above with respect to the other data sources. For instance, as one possibility, the user input may include certain kinds of operating data, maintenance data, and/or environmental data that may be input into asset data platform 102 by a user rather than being received from one of the aforementioned data sources. As another possibility, the user input may include certain user-defined settings or logic that is to be used by asset data platform 102 when performing data ingestion and/or data analytics operations. The user input that is entered into client station 104E and sent to asset data platform 102 may take various other forms as well.

The aforementioned data sources 104 are merely provided for purposes of illustration, and it should be understood that the asset data platform's data sources may take various other forms as well. For instance, while FIG. 1 shows several different types of data sources 104, it should be understood that asset data platform 102 need not be configured to receive asset-related data from all of these different types of data sources, and in fact, asset data platform 102 could be configured to receive asset-related data from as little as a single data source 104. Further, while data sources 104A-E have been shown and described separately, it should be understood that these data sources may be combined together as part of the same physical computing system (e.g., an organization's existing data platform may serve as both operating data source 104B and maintenance data source 104C). Further yet, it should be understood that asset data platform 102 may be configured to receive other types of data related to the operation and/or management of assets as well, examples of which may include asset management data (e.g., route schedules and/or operational plans), enterprise data (e.g., point-of-sale (POS) data, customer relationship management (CRM) data, enterprise resource planning (ERP) data, etc.), and/or financial markets data, among other possibilities.

As shown in FIG. 1, asset data platform 102 may also be configured to output asset-related data and/or instructions for receipt by one or more output systems 106. These output systems—and the data and/or instructions provided to such output systems—may take various forms. To illustrate, FIG. 1 shows some representative examples of output systems 106 that may receive asset-related data and/or instructions from asset data platform 102, which are discussed in further detail below. However, it should be understood that these example output systems are merely provided for purposes of illustration, and that asset data platform 102 may be configured to output asset-related data and/or instructions to other types of output systems as well.

For instance, one type of output system 106 may take the form of client station 106A, which may comprise any computing device that is configured to receive asset-related data from asset data platform 102 over the respective communication path between client station 106A and asset data platform 102 and then present such data to a user (e.g., via a front-end application that is defined by asset data platform 102). In this respect, client station 106A may take any of various forms, examples of which may include a desktop computer, a laptop, a netbook, a tablet, a smartphone, and/or a PDA, among other possibilities. Further, it should be understood that client station 106A could either be a different device than client station 104E or could be the same device as client station 104E.

The asset-related data that is output for receipt by client station 106A may take various forms. As one example, this asset-related data may include a restructured version of asset-related data that was received by asset data platform 102 from one or more data sources 104 (e.g., operating data, maintenance data, etc.). As another example, this asset-related data may include data that is generated by asset data platform 102 based on the asset-related data received from data sources 104, such as data resulting from the data analytics operations performed by asset data platform 102 (e.g., predicted failures, recommendations, alerts, etc.). Other examples are possible as well.

Along with the asset-related data that is output for receipt by client station 106A, asset data platform 102 may also output associated data and/or instructions that define the visual appearance of a front-end application (e.g., a graphical user interface (GUI)) through which the asset-related data is to be presented on client station 106A. Such data and/or instructions for defining the visual appearance of a front-end application may take various forms, examples of which may include Hypertext Markup Language (HTML), Cascading Style Sheets (CSS), and/or JavaScript, among other possibilities. However, depending on the circumstance, it is also possible that asset data platform 102 may output asset-related data to client station 106A without any associated data and/or instructions for defining the visual appearance of a front-end application.

Further, client station 106A may receive asset-related data from asset data platform 102 in various manners. As one possibility, client station 106A may send a request to asset data platform 102 for certain asset-related data and/or a certain front-end application, and client station 106A may then receive asset-related data in response to such a request. As another possibility, asset data platform 102 may be configured to “push” certain types of asset-related data to client station 106A, such as scheduled or event-based alerts, in which case client station 106A may receive asset-related data from asset data platform 102 in this manner. As yet another possibility, asset data platform 102 may be configured to make certain types of asset-related data available via an API, a service, or the like, in which case client station 106A may receive asset-related data from asset data platform 102 by accessing such an API or subscribing to such a service. Client station 106A may receive asset-related data from asset data platform 102 in other manners as well.

Another type of output system 106 may take the form of a data platform 106B operated by a third-party organization interested in the operation and/or management of assets, such as an asset owner, an asset dealer, an asset manufacturer, an asset repair shop, or the like. For instance, a third-party organization such as this may have its own data platform 106B that already enables users to access and/or interact with asset-related data through front-end applications that have been created by the third-party organization, but data platform 106B may not be programmed with the capability to ingest certain types of asset-related data or perform certain types of data analytics operations. In such a scenario, asset data platform 102 may be configured to output certain asset-related data for receipt by data platform 106B.

The asset-related data that is output for receipt by data platform 106B may take various forms, including but not limited any of the forms described above in connection with the output to client station 106A. However, unlike for client station 104A, the asset-related data that is output for receipt by data platform 106B typically need not include any associated data and/or instructions for defining the visual appearance of a front-end application, because data platform 106B may be performing operations on the asset-related data from asset data platform 102 beyond presenting it to a user via a front-end application.

Further, data platform 106B may receive asset-related data from asset data platform 102 in various manners, including but not limited to any of the manners discussed above with respect to client station 106A (e.g., by sending a request to asset data platform 102, having data “pushed” by asset data platform, or accessing an API or service provided by asset data platform 102).

Yet another type of output system 106 may take the form of asset 106C, which may be equipped with components that are configured to receive asset-related data and/or instructions from asset data platform 102 and then act in accordance with the received data and/or instructions. In this respect, asset 106C may take any of the various forms described above, including but not limited to a transport vehicle, heavy equipment, manufacturing equipment, electric power generation equipment, and/or petroleum production equipment, among other types of assets. Further, it should be understood that asset 106C could either be a different asset than asset 104A or could be the same asset as asset 104A.

The asset-related data and/or instructions that are output for receipt by asset 106C may take various forms. As one example, asset data platform 102 may be configured to send asset 106C certain data that has been generated by asset data platform 102 based on the asset-related data received from data sources 104, such as data resulting from a data analytics operation performed by asset data platform 102 (e.g., predicted failures, recommendations, alerts, etc.), in which case asset 106C may receive this data and then potentially adjust its operation in some way based on the received data. As another example, asset data platform 102 may be configured to generate and send an instruction for asset 106C to adjust its operation in some way (e.g., based on the asset-related data received from data sources 104), in which case asset 106C may receive this instruction and then potentially adjust its operation in accordance with the instruction. As yet another example, asset data platform 102 may be configured to generate and send an instruction for asset 106C to perform a data analytics operation locally at asset 106C, in which case asset 106C may receive the instruction and then locally perform the data analytics operation. In some cases, in conjunction with sending asset 106C an instruction to perform a data analytics operation, asset data platform 102 may also provide asset 106C with executable program instructions and/or program data that enable asset 106C to perform the data analytics operation (e.g., a predictive model). However, in other cases, asset 106C may already be provisioned with executable program instructions for performing the data analytics operation. Other examples are possible as well.

Further, in practice, asset 106C may receive asset-related data and/or instructions from asset data platform 102 in various manners, including but not limited to any of the manners discussed above with respect to client station 106A.

Still another type of output system 106 may take the form of work-order system 106D, which may comprise a computing system that is configured to receive asset-related data and/or instructions from asset data platform 102 over the respective communication path between work-order system 106D and asset data platform 102 and then generate a work order in accordance with the received data and/or instructions.

A further type of output system 106 may take the form of parts-ordering system 106E, which may comprise a computing system that is configured to receive asset-related data and/or instructions from asset data platform 102 over the respective communication path between parts-ordering system 106E and asset data platform 102 and then generate a parts order in accordance with the received data and/or instructions.

The aforementioned output systems 106 are merely provided for purposes of illustration, and it should be understood that output systems in communication with asset data platform 102 may take various other forms as well. For instance, while FIG. 1 shows several different types of output systems 106, it should be understood that asset data platform 102 need not be configured to output asset-related data and/or instructions for receipt by all of these different types of output systems, and in fact, asset data platform 102 could be configured to output asset-related data and/or instructions for receipt by as little as a single output system 106. Further, while output systems 106A-E have been shown and described separately, it should be understood that these output systems may be combined together as part of the same physical computing system. Further yet, it should be understood that asset data platform 102 may be configured to output asset-related data and/or instructions for receipt by other types of output systems as well.

As discussed above, asset data platform 102 may communicate with the one or more data sources 104 and one or more output systems 106 over respective communication paths. Each of these communication paths may generally comprise one or more communication networks and/or communications links, which may take any of various forms. For instance, each respective communication path with asset data platform 102 may include any one or more of point-to-point links, Personal Area Networks (PANs), Local-Area Networks (LANs), Wide-Area Networks (WANs), such as the Internet or cellular networks, cloud networks, and/or operational technology (OT) networks, among other possibilities. Further, the communication networks and/or links that make up each respective communication path with asset data platform 102 may be wireless, wired, or some combination thereof, and may carry data according to any of various different communication protocols.

Although not shown, the respective communication paths with asset data platform 102 may also include one or more intermediate systems. For example, it is possible that a given data source 104 may send asset-related data to one or more intermediary systems, such as an aggregation system, and asset data platform 102 may then be configured to receive the asset-related data from the one or more intermediary systems. As another example, it is possible that asset data platform 102 may communicate with a given output system 106 via one or more intermediary systems, such as a host server (not shown). Many other configurations are also possible.

It should be understood that network configuration 100 is one example of a network configuration in which embodiments described herein may be implemented. Numerous other arrangements are possible and contemplated herein. For instance, other network configurations may include additional components not pictured and/or more or less of the pictured components.

### II. EXAMPLE PLATFORM

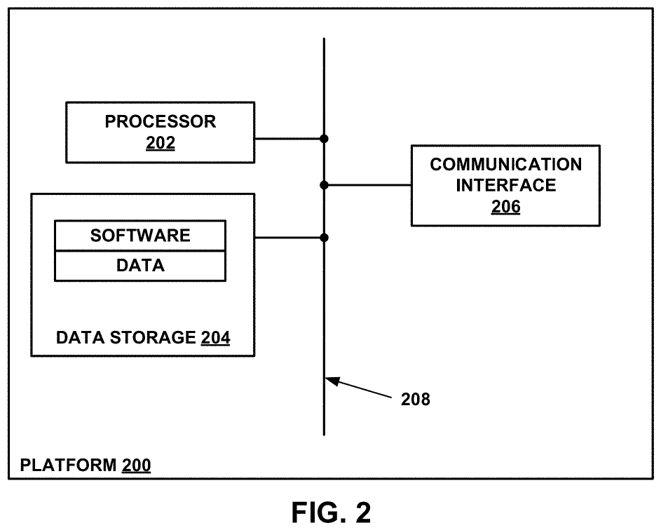

FIG. 2 is a simplified block diagram illustrating some structural components that may be included in an example computing platform 200, which could serve as the asset data platform 102 in FIG. 1. In line with the discussion above, platform 200 may generally comprise one or more computer systems (e.g., one or more servers), and these one or more computer systems may collectively include at least a processor 202, data storage 204, and a communication interface 206, all of which may be communicatively linked by a communication link 208 that may take the form of a system bus, a communication network such as a public, private, or hybrid cloud, or some other connection mechanism.

Processor 202 may comprise one or more processor components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that processor 202 could comprise processing components that are distributed across a plurality of physical computing devices connected via a network, such as a computing cluster of a public, private, or hybrid cloud.

In turn, data storage 204 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 204 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 2, data storage 204 may be provisioned with software components that enable the platform 200 to carry out the functions disclosed herein. These software components may generally take the form of program instructions that are executable by the processor 202 to carry out the disclosed functions, which may be arranged together into software applications, virtual machines, software development kits, toolsets, or the like.

Further, data storage 204 may be arranged to store asset-related data in one or more databases, file systems, or the like. For example, data storage 204 may be configured to store data using technologies such Apache Cassandra, Apache Hadoop, PostgreSQL, and/or MongoDB, among other possibilities. Data storage 204 may take other forms and/or store data in other manners as well.

Communication interface 206 may be configured to facilitate wireless and/or wired communication with data sources and output systems, such as data sources 104 and output systems 106 in FIG. 1. Additionally, in an implementation where platform 200 comprises a plurality of physical computing devices connected via a network, communication interface 206 may be configured to facilitate wireless and/or wired communication between these physical computing devices (e.g., between computing and storage clusters in a cloud network). As such, communication interface 206 may take any suitable form for carrying out these functions, examples of which may include an Ethernet interface, a serial bus interface (e.g., Firewire, USB 2.0, etc.), a chipset and antenna adapted to facilitate wireless communication, and/or any other interface that provides for wireless and/or wired communication. Communication interface 206 may also include multiple communication interfaces of different types. Other configurations are possible as well.

Although not shown, platform 200 may additionally include one or more interfaces that provide connectivity with external user-interface equipment (sometimes referred to as “peripherals”), such as a keyboard, a mouse or trackpad, a display screen, a touch-sensitive interface, a stylus, a virtual-reality headset, speakers, etc., which may allow for direct user interaction with platform 200.

It should be understood that platform 200 is one example of a computing platform that may be used with the embodiments described herein. Numerous other arrangements are possible and contemplated herein. For instance, other computing platforms may include additional components not pictured and/or more or less of the pictured components.

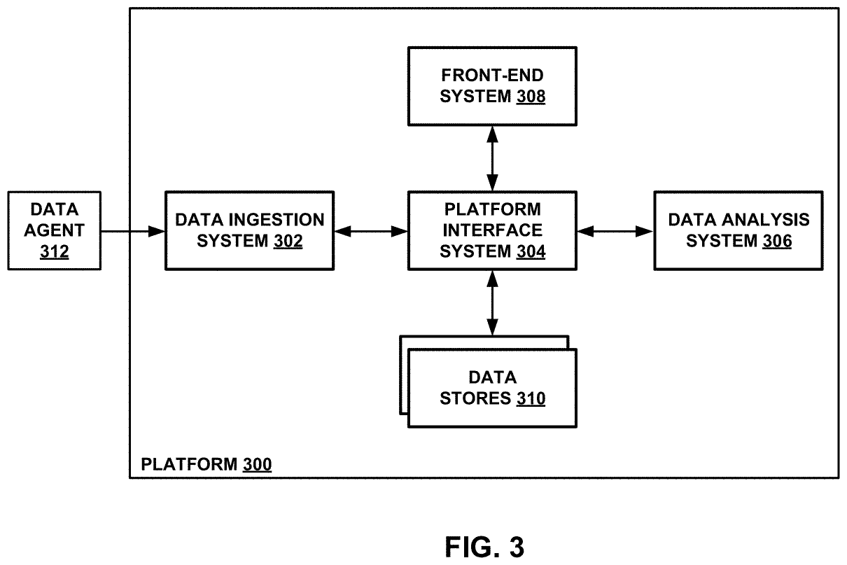

Referring now to FIG. 3, another simplified block diagram is provided to illustrate some functional systems that may be included in an example platform 300. For instance, as shown, the example platform 300 may include a data ingestion system 302, a platform interface system 304, a data analysis system 306, a front-end system 308, and one or more data stores 310, each of which comprises a combination of software and hardware that is configured to carry out particular functions. In line with the discussion above, these functional systems may be implemented on one or more computing systems, which may take the form of computing infrastructure of a public, private, and/or hybrid cloud or one or more dedicated servers, among other possibilities.

At a high level, data ingestion system 302 may be configured to ingest asset-related data received from the platform's one or more data sources, transform the ingested data into a standardized structure, and then pass the ingested data to platform interface system 304. In this respect, the function of ingesting received data may be referred to as the “extraction” (or “acquisition”) stage within data ingestion system 302, the function of transforming the ingested data into a desired structure may be referred to as the “transformation” stage within data ingestion system 302, and the function of passing the ingested data to platform interface system 304 may be referred to as the “load” stage within data ingestion system 302. (Alternatively, these functions may collectively be referred to as the ETL stage). In some embodiments, data ingestion system 302 may also be configured to enhance the ingested data before passing it to platform interface system 304. This function of enhancing the ingested data may be referred to as the “enhancement” stage within data ingestion system 302. However, data ingestion system 302 may take various other forms and perform various other functions as well.

At the extraction stage, data ingestion system 302 may be configured to receive and ingest various types of asset-related data from various types of data sources, including but not limited to the types of asset-related data and data sources 104 discussed above with reference to FIG. 1. Further, in line with the discussion above, data ingestion system 302 may be configured to receive asset-related data from a data source in various manners. For instance, as one possibility, data ingestion system 302 may be configured to receive batch transmissions of asset-related data from a data source. As another possibility, data ingestion system 302 may be configured to receive asset-related data from a data source in a streaming fashion. As yet another possibility, data ingestion system 302 may be configured to receive asset-related data from a data source in response to sending a request for such data to the data source, in which case data ingestion system 302 may be configured to periodically send requests for asset-related data to the data source. As still another possibility, data ingestion system 302 may receive asset-related data from a data source by subscribing to a service provided by the data source (e.g., via an API or the like). Data ingestion system 302 may be configured to receive asset-related data from a data source in other manners as well.

Before data ingestion system 302 receives asset-related data from certain data sources, there may also be some configuration that needs to place at such data sources. For example, a data source may be configured to output the particular set of asset-related data that is of interest to platform 300. To assist with this process, the data source may be provisioned with a data agent 312, which generally comprises a software component that functions to access asset-related data at the given data source, place the data in the appropriate format, and then facilitate the transmission of that data to platform 300 for receipt by data ingestion system 302. In other cases, however, the data sources may be capable of accessing, formatting, and transmitting asset-related data to platform 300 without the assistance of a data agent.

Turning to the transformation phase, data ingestion system 302 may generally be configured to map and transform ingested data into one or more predefined data structures, referred to as “schemas,” in order to standardize the ingested data. As part of this transformation stage, data ingestion system 302 may also drop any data that cannot be mapped to a schema.

In general, a schema is an enforceable set of rules that define the manner in which data is to be structured in a given system, such as a data platform, a data store, etc. For example, a schema may define a data structure comprising an ordered set of data fields that each have a respective field identifier (e.g., a name) and a set of parameters related to the field's value (e.g., a data type, a unit of measure, etc.). In such an example, the ingested data may be thought of as a sequence of data records, where each respective data record includes a respective snapshot of values for the defined set of fields. The purpose of a schema is to define a clear contract between systems to help maintain data quality, which indicates the degree to which data is consistent and semantically correct.

In some implementations, data ingestion system 302 may also be configured to map and transform different types of asset-related data to different schemas. For instance, if the asset-related data received from different data sources is to be input into different types of data analytics operations that have different input formats, it may be advantageous to map and transform such asset-related data received from the different data sources to different schemas.

As part of the transformation stage, data ingestion system 302 may also be configured to perform various other quality checks on the asset-related data before passing it to platform interface system 304. For example, data ingestion system 302 may assess the reliability (or “health”) of certain ingested data and take certain actions based on this reliability, such as dropping any unreliable data. As another example, data ingestion system 302 may “de-dup” certain ingested data by comparing it against data that has already been received by platform 300 and then ignoring or dropping duplicative data. As yet another example, data ingestion system 302 may determine that certain ingested data is related to data already stored in the platform's data stores (e.g., a different version of the same data) and then merge the ingested data and stored data together into one data structure or record. Data ingestion system 302 may perform other types of quality checks as well.

It should also be understood that certain data ingested by data ingestion system 302 may not be transformed to a predefined schema (i.e., it is possible that certain ingested data will be “passed through” without performing any transformation on the data), in which case platform 300 may operate on this ingested data as it exists in its original data structure.

As noted above, in some embodiments, data ingestion system 302 may also include an “enhancement” stage where data ingestion system 302 enhances the ingested data before passing it to platform interface system 304. In this respect, data ingestion system 302 may enhance the ingested data in various manners. For instance, data ingestion system 302 may supplement the ingested data with additional asset-related data that is derived by and/or otherwise accessible to platform 300. Such additional data may take various forms. As one example, if the ingested data comprises sensor data, data ingestion system 302 may be configured to supplement the sensor data with “roll-up” data and/or “features” data that is derived from the sensor data. As another possible example, data ingestion system 302 may generate and append certain “enrichments” to the ingested data, examples of which are described in U.S. application Ser. No. 16/004,652, which is incorporated by reference herein in its entirety. Data ingestion system 302 may enhance the ingested data in other manners as well.

After data ingestion system 302 has performed any appropriate transformation and/or enhancement operations on the ingested data, it may pass the ingested data to platform interface system 304, which may be configured to receive data from data ingestion system 302, store the received data in one or more of data stores 310, and make the data available for consumption by the other functional systems of platform 300—including data analysis system 306 and/or front-end system 308. In this respect, the function of passing the ingested data from data ingestion system 302 to platform interface system 304 may take various forms.

According to an example implementation, data ingestion system 302 may begin by categorizing the ingested data into separate data categories (or “domains”) that are to be consumed separately by the platform's other functional systems. In turn, data ingestion system 302 may publish the data within each category to a corresponding interface (e.g., an API or the like) that is provided by platform interface system 304. However, it should be understood that other approaches for passing the ingested data from data ingestion system 302 to platform interface system 304 may be used as well, including the possibility that data ingestion system 302 may simply publish the ingested data to a given interface of platform interface system 304 without any prior categorization of the ingested data.

After platform interface system 304 receives the ingested data from data ingestion system 302, platform interface system 304 may cause that data to be stored at the appropriate data stores 310 within platform 300. For instance, in the event that platform interface system 304 is configured to receive different categories of ingested data, platform interface system 304 may be configured store data from a first category into a first data store 310, store data from a second category into a second data store 310, and so on. In addition, platform interface system 304 may store an archival copy of the ingested data into an archival data store 310. Platform interface system 304 may store the ingested data in other manners as well.

After receiving the ingested data from data ingestion system 302, platform interface system 304 may also make the ingested data available for consumption by the platform's other functional systems—including data analysis system 306 and front-end system 308. In this respect, platform interface system 304 may make the ingested data available for consumption in various manners, including through the use of message queues or the like.

After consuming data from platform interface system 304, data analysis system 306 may generally function to perform data analytics operations on such data and then pass the results of those data analytics operations back to platform interface system 304. These data analytics operations performed by data analysis system 306 may take various forms.

As one possibility, data analysis system 306 may create and/or execute predictive models related to asset operation based on asset-related data received from one or more data sources, such as predictive models that are configured to predict occurrences of failures at an asset. One example of a predictive model that may be created and executed by data analysis system 306 is described in U.S. application Ser. No. 14/732,258, which is incorporated by reference herein in its entirety.

As another possibility, data analysis system 306 may create and/or execute models for detecting anomalies in asset-related data received from one or more data sources. Some examples of anomaly detection models that may be created and executed by data analysis system 306 are described in U.S. application Ser. Nos. 15/367,012 and 15/788,622, which are incorporated by reference herein in their entirety.

As yet another possibility, data analysis system 306 may be configured to create and/or execute other types of data analytics programs based on asset-related data received from one or more data sources, examples of which include data analytics programs that evaluate asset-related data using a set of predefined rules (e.g., threshold-based rules), data analytics programs that generate predictive recommendations, data analytics programs that perform noise filtering, and data analytics programs that perform image analysis, among other possibilities.

The data analytics operations performed by data analysis system 306 may take various other forms as well.

Further, it should be understood that some of the data analytics operations discussed above may involve the use of machine learning techniques, examples of which may include regression, random forest, support vector machines (SVM), artificial neural networks, Naïve Bayes, decision trees, dimensionality reduction, k-nearest neighbor (kNN), gradient boosting, clustering, and association, among other possibilities.

As discussed above, after performing its data analytics operations, data analysis system 306 may then pass the results of those operations back to platform interface system 304, which may store the results in the appropriate data store 310 and make such results available for consumption by the platform's other functional systems—including data analysis system 306 and front-end system 308.

In turn, front-end system 308 may generally be configured to drive front-end applications that may be presented to a user via a client station (e.g., client station 106A). Such front-end applications may take various forms. For instance, as discussed above, some possible front-end applications for platform 300 may include an asset performance management application, an asset fleet management application, a service optimization application, and/or an asset dealer operations application, among other possibilities.

In practice, front-end system 308 may generally function to access certain asset-related data from platform interface system 304 that is to be presented to a user as part of a front-end application and then provide such data to the client station along with associated data and/or instructions that define the visual appearance of the front-end application. Additionally, front-end system 308 may function to receive user input that is related to the front-end applications for platform 300, such as user requests and/or user data. Additionally yet, front-end system 308 may support a software development kit (SDK) or the like that allows a user to create customized front-end applications for platform 300. Front-end system 308 may perform other functions as well.

Platform 300 may also include other functional systems that are not shown. For instance, although not shown, platform 300 may include one or more additional functional systems that are configured to output asset-related data and/or instructions for receipt by other output systems, such as third-party data platforms, assets, work-order systems, parts-ordering systems, or the like.

One of ordinary skill in the art will appreciate that the example platform shown in FIGS. 2-3 is but one example of a simplified representation of the structural components and/or functional systems that may be included in a platform, and that numerous others are also possible. For instance, other platforms may include structural components and/or functional systems not pictured and/or more or less of the pictured structural components and/or functional systems. Moreover, a given platform may include multiple, individual platforms that are operated in concert to perform the operations of the given platform. Other examples are also possible.

### III. EXAMPLE ASSET

As discussed above with reference to FIG. 1, asset data platform 102 may be configured to perform functions to facilitate the monitoring, analysis, and/or management of various types of assets, examples of which may include transport vehicles (e.g., locomotives, aircrafts, passenger vehicles, trucks, ships, etc.), equipment for construction, mining, farming, or the like (e.g., excavators, bulldozers, dump trucks, earth movers, etc.), manufacturing equipment (e.g., robotics devices, conveyor systems, and/or other assembly-line machines), electric power generation equipment (e.g., wind turbines, gas turbines, coal boilers), petroleum production equipment (e.g., gas compressors, distillation columns, pipelines), and data network nodes (e.g., personal computers, routers, bridges, gateways, switches, etc.), among other examples.

Broadly speaking, an asset may comprise a combination of one or more electrical, mechanical, electromechanical, and/or electronic components that are designed to perform one or more tasks. Depending on the type of asset, such components may take various forms. For instance, a transport vehicle may include an engine, a transmission, a drivetrain, a fuel system, a battery system, an exhaust system, a braking system, a generator, a gear box, a rotor, and/or hydraulic systems, which work together to carry out the tasks of a transport vehicle. However, other types of assets may include other various other types of components.

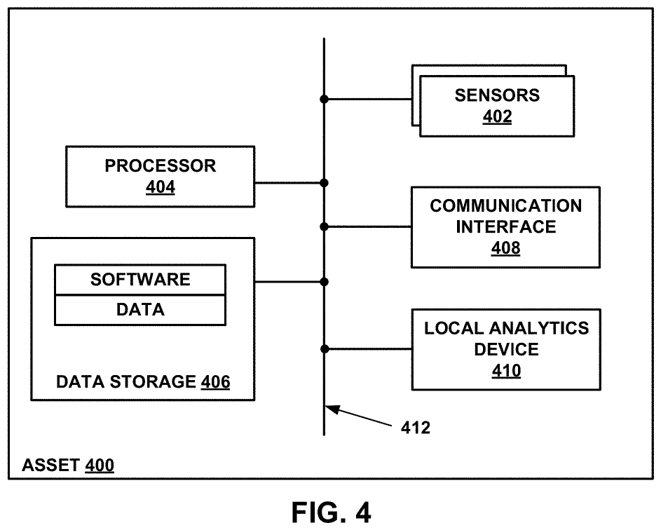

In addition to the aforementioned components, an asset may also be equipped with a set of on-board components that enable the asset to capture and report operating data. To illustrate, FIG. 4 is simplified block diagram showing some on-board components for capturing and reporting operating data that may be included within or otherwise affixed to an example asset 400. As shown, these on-board components may include sensors 402, a processor 404, data storage 406, a communication interface 408, and perhaps also a local analytics device 410, all of which may be communicatively coupled by a communication link 412 that may take the form of a system bus, a network, or other connection mechanism.

In general, sensors 402 may each be configured to measure the value of a respective operating parameter of asset 400 and then output data that indicates the measured value of the respective operating parameter over time. In this respect, the operating parameters of asset 400 that are measured by sensors 402 may vary depending on the type of asset, but some representative examples may include speed, velocity, acceleration, location, weight, temperature, pressure, friction, vibration, power usage, throttle position, fluid usage, fluid level, voltage, current, magnetic field, electric field, presence or absence of objects, current position of a component, and power generation, among many others.

In practice, sensors 402 may each be configured to measure the value of a respective operating parameter continuously, periodically (e.g., based on a sampling frequency), and/or in response to some triggering event. In this respect, each sensor 402 may have a respective set of operating parameters that defines how the sensor performs its measurements, which may differ on a sensor-by-sensor basis (e.g., some sensors may sample based on a first frequency, while other sensors sample based on a second, different frequency). Similarly, sensors 402 may each be configured to output data that indicates the measured value of its respective operating parameter continuously, periodically (e.g., based on a sampling frequency), and/or in response to some triggering event.

Based on the foregoing, it will be appreciated that sensors 402 may take various different forms depending on the type of asset, the type of operating parameter being measured, etc. For instance, in some cases, a sensor 402 may take the form of a general-purpose sensing device that has been programmed to measure a particular type of operating parameter. In other cases, a sensor 402 may take the form of a special-purpose sensing device that has been specifically designed to measure a particular type of operating parameter (e.g., a temperature sensor, a GPS receiver, etc.). In still other cases, a sensor 402 may take the form of a special-purpose device that is not primarily designed to operate as a sensor but nevertheless has the capability to measure the value of an operating parameter as well (e.g., an actuator). Sensors 402 may take other forms as well.

Processor 404 may comprise one or more processor components, such as general-purpose processors, special-purpose processors, programmable logic devices, controllers, and/or any other processor components now known or later developed. In turn, data storage 406 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc.

As shown in FIG. 4, data storage 406 may be arranged to contain executable program instructions (i.e., software) that cause asset 400 to perform various functions related to capturing and reporting operating data, along with associated data that enables asset 400 to perform these operations. For example, data storage 406 may contain executable program instructions that cause asset 400 to obtain sensor data from sensors 402 and then transmit that sensor data to another computing system (e.g., asset data platform 102). As another example, data storage 406 may contain executable program instructions that cause asset 400 to evaluate whether the sensor data output by sensors 402 is indicative of any abnormal conditions at asset 400 (e.g., by applying logic such as threshold-based rules to the measured values output by sensors 402), and then if so, to generate abnormal-condition data that indicates occurrences of abnormal conditions. The executable program instructions and associated data stored in data storage 406 may take various other forms as well.

Communication interface 408 may be configured to facilitate wireless and/or wired communication between asset 400 and various computing systems, including an asset data platform such as asset data platform 102. As such, communication interface 408 may take any suitable form for carrying out these functions, examples of which may include a chipset and antenna adapted to facilitate wireless communication, an Ethernet interface, a serial bus interface (e.g., Firewire, USB 2.0, etc.), and/or any other interface that provides for wireless and/or wired communication. Communication interface 408 may also include multiple communication interfaces of different types. Other configurations are possible as well. It should also be understood that asset 400 may not be equipped with its own on-board communication interface 408.

In some circumstances, it may also be desirable to perform certain data analytics operations locally at asset 400, rather than relying on a central platform to perform data analytics operations. Indeed, performing data analytics operations locally at asset 400 may reduce the need to transmit operating data to a centralized platform, which may reduce the cost and/or delay associated with performing data analytics operations at the central platform and potentially also increase the accuracy of certain data analytics operations, among other advantages.

In this respect, in some cases, the aforementioned on-board components of asset 400 (e.g., processor 404 and data storage 406) may provide sufficient computing power to locally perform data analytics operations at asset 400, in which case data storage 406 may be provisioned with executable program instructions and associated program data for performing the data analytics operations. However, in other cases, the aforementioned on-board components of asset 400 (e.g., processor 404 and/or data storage 406) may not provide sufficient computing power to locally perform certain data analytics operations at asset 400. In such cases, asset 400 may also optionally be equipped with local analytics device 410, which may comprise a computing device that is capable of performing data analytics operations and other complex operations that go beyond the capabilities of the asset's other on-board components. In this way, local analytics device 410 may generally serve to expand the on-board capabilities of asset 400.

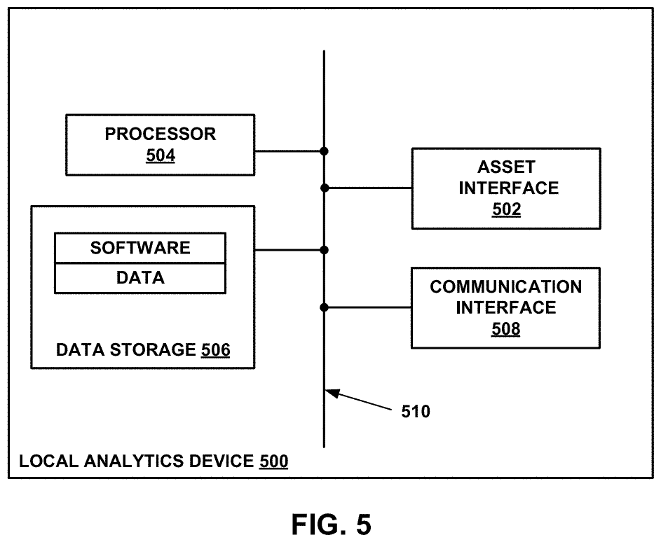

FIG. 5 illustrates a simplified block diagram showing some components that may be included in an example local analytics device 500. As shown, local analytics device 500 may include an asset interface 502, a processor 504, data storage 506, and a communication interface 508, all of which may be communicatively coupled by a communication link 510 that may take the form of a system bus, a network, or other connection mechanism.

Asset interface 502 may be configured to couple local analytics device 500 to the other on-board components of asset 400. For instance, asset interface 502 may couple local analytics device 500 to processor 404, which may enable local analytics device 500 to receive data from processor 404 (e.g., sensor data output by sensors 402) and to provide instructions to processor 404 (e.g., to control the operation of asset 400). In this way, local analytics device 500 may indirectly interface with and receive data from other on-board components of asset 400 via processor 404. Additionally or alternatively, asset interface 502 may directly couple local analytics device 500 to one or more sensors 402 of asset 400. Local analytics device 500 may interface with the other on-board components of asset 400 in other manners as well.

Processor 504 may comprise one or more processor components that enable local analytics device 500 to execute data analytics programs and/or other complex operations, which may take the form of general-purpose processors, special-purpose processors, programmable logic devices, controllers, and/or any other processor components now known or later developed. In turn, data storage 506 may comprise one or more non-transitory computer-readable storage mediums that enable local analytics device 500 to execute data analytics programs and/or other complex operations, examples of which may include volatile storage mediums such as random-access memory, registers, cache, etc. and non-volatile storage mediums such as read-only memory, a hard-disk drive, a solid-state drive, flash memory, an optical-storage device, etc.

As shown in FIG. 5, data storage 506 may be arranged to contain executable program instructions (i.e., software) that cause local analytics device 500 to perform data analytics operations and/or other complex operations that go beyond the capabilities of the asset's other on-board components, as well as associated data that enables local analytics device 500 to perform these operations.

Communication interface 508 may be configured to facilitate wireless and/or wired communication between local analytics device 500 and various computing systems, including an asset data platform such as asset data platform 102. In this respect, local analytics device 500 may communicate the results of its operations to an asset data platform via communication interface 508, rather than via an on-board communication interface of asset 400. Further, in circumstances where asset 400 is not be equipped with its own on-board communication interface, asset 400 may use communication interface 508 to transmit operating data to an asset data platform. As such, communication interface 508 may take any suitable form for carrying out these functions, examples of which may include a chipset and antenna adapted to facilitate wireless communication, an Ethernet interface, a serial bus interface (e.g., Firewire, USB 2.0, etc.), and/or any other interface that provides for wireless and/or wired communication. Communication interface 508 may also include multiple communication interfaces of different types. Other configurations are possible as well.

In addition to the foregoing, local analytics device 500 may also include other components that can be used to expand the on-board capabilities of an asset. For example, local analytics device 500 may optionally include one or more sensors that are configured to measure certain parameters, which may be used to supplement the sensor data captured by the asset's on-board sensors. Local analytics device 500 may include other types of components as well.

Returning to FIG. 4, although not shown, asset 400 may also be equipped with hardware and/or software components that enable asset 400 to adjust its operation based on asset-related data and/or instructions that are received at asset 400 (e.g., from asset data platform 102 and/or local analytics device 410). For instance, as one possibility, asset 400 may be equipped with one or more of an actuator, motor, value, solenoid, or the like, which may be configured to alter the physical operation of asset 400 in some manner based on commands received from processor 404. In this respect, data storage 406 may additionally be provisioned with executable program instructions that cause processor 404 to generate such commands based on asset-related data and/or instructions received via communication interface 408. Asset 400 may be capable of adjusting its operation in other manners as well.

Further, although not shown, asset 400 may additionally include one or more interfaces that provide connectivity with external user-interface equipment (sometimes referred to as “peripherals”), such as a keyboard, a mouse or trackpad, a display screen, a touch-sensitive interface, a stylus, a virtual-reality headset, speakers, etc., which may allow for direct user interaction with the on-board components of asset 400.

One of ordinary skill in the art will appreciate that FIGS. 4-5 merely show one example of the components of an asset, and that numerous other examples are also possible. For instance, the components of an asset may include additional components not pictured, may have more or less of the pictured components, and/or the aforementioned components may be arranged and/or integrated in a different manner. Further, one of ordinary skill in the art will appreciate that two or more of the components of asset 400 may be integrated together in whole or in part. Further yet, one of ordinary skill in the art will appreciate that at least some of these components of asset 400 may be affixed or otherwise added to asset 400 after it has been placed into operation.

### IV. EXAMPLE OPERATIONS

As noted above, a data analytics platform, such as asset data platform 102, may be configured to perform various computing tasks to facilitate monitoring, analyzing, and/or making predictions about the operation of assets in a real-world operating environment, such as a rail network, a construction or mining site, etc., and many of these computing tasks may be compute intensive (e.g., in terms of the processing and/or storage resources required to carry out these tasks, the time it takes to carry out these tasks, etc.).

In practice, certain compute-intensive computing tasks may involve an analysis of certain types of complex data, such as a set of environmental data associated with an environment in which assets are operating, which may take the form of a geospatial dataset that defines the operating environment. As noted before, a geospatial dataset generally comprises nodes, linestrings, and polygons. A node generally represents a point-type feature in a geographic environment, such as a particular latitude, longitude, and altitude position. Two or more interconnected nodes define a linestring, which generally represents a line-type feature in a geographic environment, such as a road, railway, river, power line, etc. In a linestring that includes more than two nodes, the nodes corresponding to the start and finish of the linestring may be referred to as “endpoint nodes,” while non-endpoint nodes of such a linestring may be referred to as “intermediate nodes.” A linestring can be composed to form a polygon, which generally represents an area-type feature in a geographic environment, such as a building, park, etc.

In some instances, a linestring may be an “edge,” which forms a boundary between two or more polygons or geographic regions. Moreover, in some instances, nodes may be placed in sets referred to as “multi-points,” linestrings may be placed in sets called “multi-linestrings,” and polygons may be placed in sets called “multi-polygons.” In certain instances, a polygon might take the form of a “complex” polygon that includes multiple area-type features, such as two or more rings or the like. Further yet, nodes of a geospatial dataset may represent a three-dimensional volume. Other aspects of geospatial data also exist.

As discussed above, in order to promote an accurate representation of an operating environment, a geospatial dataset typically comprises a large number of nodes, which compounds the compute-intensive nature of the computing tasks performed by a data analytics platform. Indeed, it will be appreciated that a geospatial dataset having a greater number of nodes will generally provide a more accurate representation of an operating environment than a geospatial dataset having fewer number of nodes. However, in line with the above discussion, a geospatial dataset that uses a greater number of nodes to represent an environment will generally impose a greater burden on a data analytics platform's ability to carry out computing tasks based on that geospatial dataset, in terms of both the processing and/or storage resources required to carry out such computing tasks and the time it takes to carry out such computing tasks.

To help address one or more of the technological issues arising in a data analytics platform performing complex computing tasks, disclosed herein is an innovative process for simplifying a geospatial dataset (or some other complex dataset) that is to be used by a data analytics system while performing certain computing tasks. The disclosed simplification process may help to reduce the computing resources required to perform these complex tasks, which may in turn improve the overall operation of the data analytics platform.

Example functions that may be carried out by a data analytics platform to simplify a geospatial dataset (or some other complex dataset) will now be discussed in detail. For purposes of illustration only, the example functions are described in the context of example network configuration 100 of FIG. 1, where asset data platform 102 is a data analytics platform configured to simplify a complex dataset and use that simplified dataset to perform certain computing tasks related to assets 104A.

To help describe some of these operations, flow diagrams may also be referenced to describe combinations of operations that may be performed. In some cases, each block may represent a module or portion of program code that includes instructions that are executable by a processor to implement specific logical functions or steps in a process. The program code may be stored on any type of computer-readable medium, such as non-transitory computer-readable media. In other cases, each block may represent circuitry that is wired to perform specific logical functions or steps in a process. Moreover, the blocks shown in the flow diagrams may be rearranged into different orders, combined into fewer blocks, separated into additional blocks, and/or removed based upon the particular embodiment.

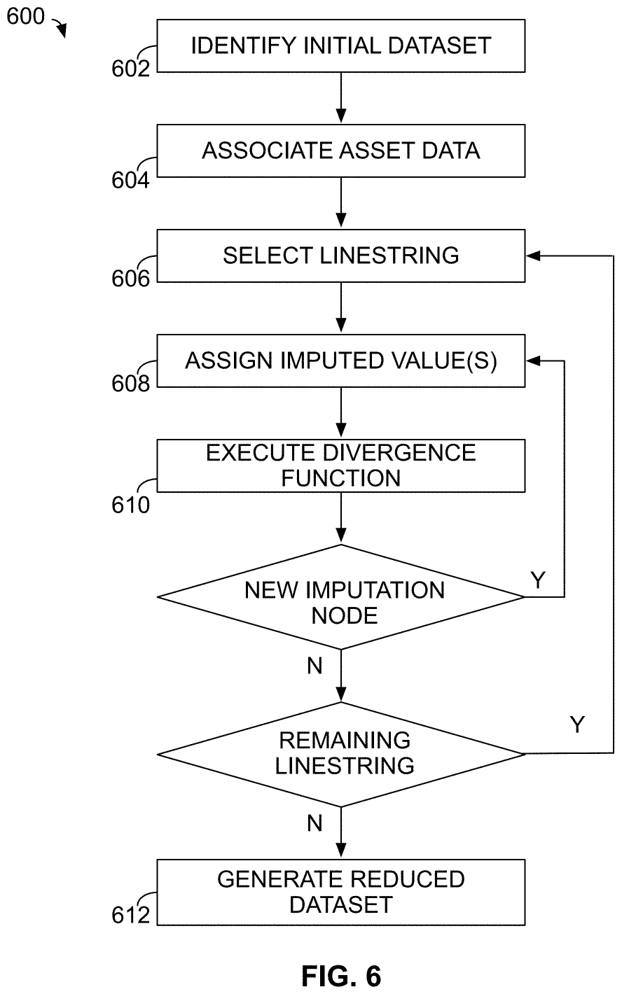

With reference now to flow diagram 600 of FIG. 6, asset data platform 102 may be configured to implement an example simplification process that generally involves (i) at block 602, identifying for evaluation an initial set of geospatial data that represents a particular operating environment for assets, where the initial geospatial dataset includes one or more linestrings that each includes multiple nodes, (ii) at block 604, for each node of at least a plurality of nodes in the initial geospatial dataset, associating a given node with an asset dataset having at least one value of a given asset data variable (e.g., asset speed, fuel consumption, etc.) that is related to how assets typically operate when located in proximity to that node, (iii) at block 606, selecting for evaluation a candidate linestring from the initial geospatial dataset, (iv) at blocks 608-610, iteratively assigning at least one imputed value of the given asset data variable to candidate nodes of the candidate linestring and executing a divergence function based thereon that determines whether any candidate nodes from the candidate linestring can be removed without causing an unacceptable loss of fidelity with respect to the associated asset data, and (v) at block 612, generating a reduced geospatial dataset after repeating steps (iii) and (iv) for each eligible linestring from the initial geospatial dataset. Each of these functions will now be discussed in further detail.

At block 602, asset data platform 102 may begin by identifying for evaluation an initial geospatial dataset that represents a particular operating environment for assets, where the initial geospatial dataset includes one or more linestrings that each includes multiple nodes. In practice, the one or more linestrings themselves may be one or more geospatial data objects (i.e., one or more individual linestrings) or may be part of a geospatial data object, such as a polygon. In other words, the initial geospatial dataset may include one or more geospatial data objects, such as linestrings and/or polygons, which comprise one or more linestrings having multiple nodes.

In operation, asset data platform 102 may receive or otherwise obtain the initial geospatial dataset that it identifies in a variety of manners. For example, asset data platform 102 may receive or obtain geospatial data from data storage of asset data platform 102 or from a geospatial data server that is located external to asset data platform 102. As another example, asset data platform 102 may receive geospatial data from one or more assets 104A that capture or otherwise produce the data. In some such examples, one or more assets 104A may provide geospatial data to asset data platform 102 in a data stream (e.g., a real-time or near real-time data stream), while in other instances, this data may be provided as a “batch,” among other possibilities. In yet another example, asset data platform 102 may receive or obtain geospatial data from some other source of geospatial data that is separate from asset data platform 102.

In any event, the initial geospatial dataset can take a variety of forms. As one possibility, the initial geospatial dataset may be organized in a data table or some other data structure. As another possibility, the initial geospatial dataset may be organized according to a particular format, such as a “shapefile” format or the like. Other possibilities also exist.

In practice, asset data platform 102 may identify the initial geospatial dataset in a variety of manners. As one possibility, asset data platform 102 may identify the initial geospatial dataset based on inputs received by client station 104E or the like that is communicatively coupled with asset data platform 102. For example, a user might operate, via client station 104E, a front-end application provided by asset data platform 102 and submit inputs at client station 104E indicating a selection of a particular operating environment of interest. Client station 104E may then send to asset data platform 102 data indicative of the selected operating environment, from which asset data platform 102 may in turn identify the initial geospatial dataset corresponding to that environment.

As another possibility, asset data platform 102 may identify the initial dataset based on an identification of one or more assets of interest. For example, based on enterprise data for a given organization provided by a data source 104, asset data platform 102 may identify the particular assets owned and/or operated by the given organization, and then, asset data platform 102 may identify historical, present, and/or future route schedules, operational plans, or the like for the identified assets. Asset data platform 102 may then identify geospatial data corresponding to the operating environment that the asset route schedules, operational plans, or the like indicate that the assets of interest traverse or otherwise operate in.

As yet another possibility, asset data platform 102 may identify the initial dataset based on certain predetermined criteria, such as temporal and/or dataset size criterion. For example, asset data platform 102 may be configured to identify geospatial data corresponding to any operating environment that certain assets traversed or otherwise operated in within the past seven days, the past month, etc., or to identify a predetermined amount of geospatial data. Other examples of identifying the initial geospatial dataset are also possible. For instance, in some implementations, asset data platform 102 may identify the initial geospatial dataset based on a combination of two or more of the above-mentioned possibilities.

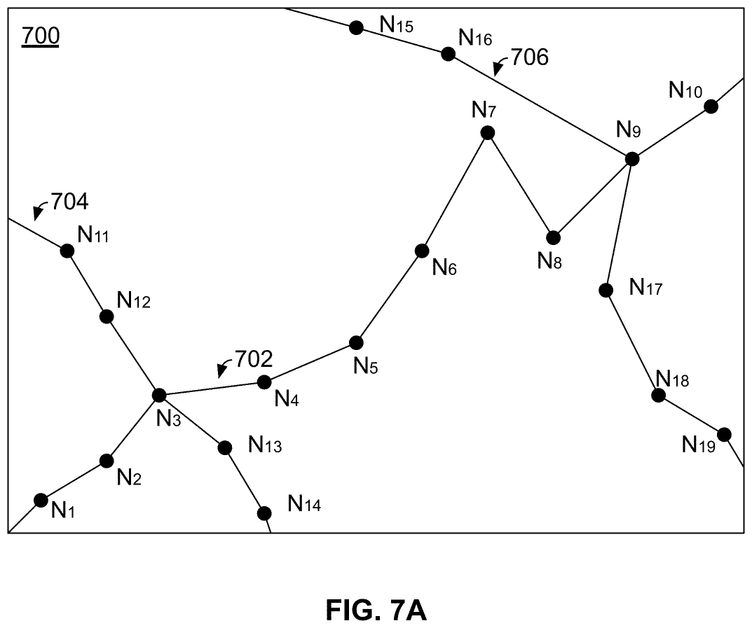

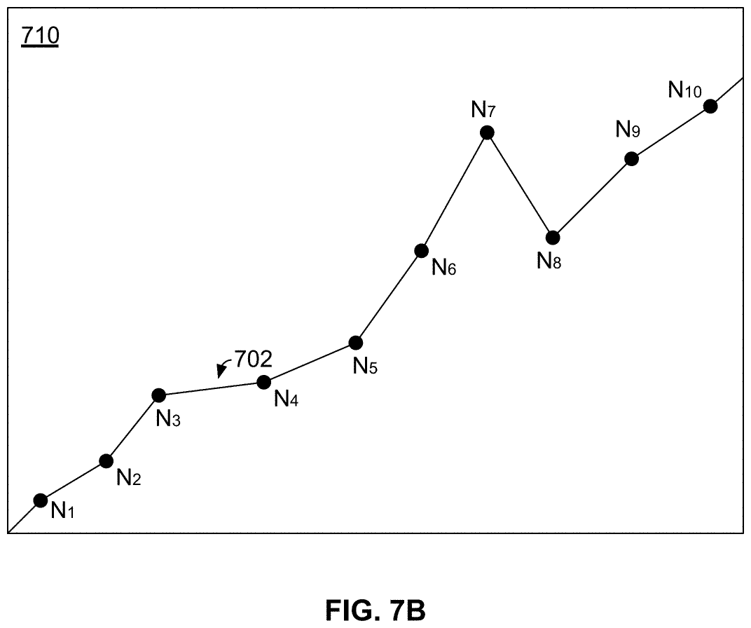

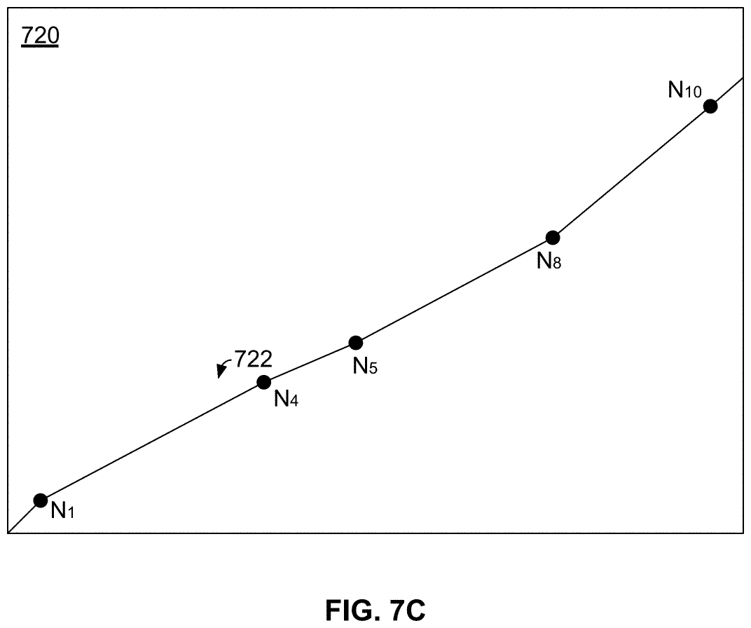

As an illustrative example, FIG. 7A provides a conceptual illustration of a geospatial dataset representing a particular geographic environment 700. As illustrated, the geospatial dataset includes several nodes N₁-N₁₀ and a linestring 702 (defined by interconnected nodes N₁-N₁₀) with endpoint nodes N₁ and N₁₀, a linestring 704 (defined by interconnected nodes N₁₁-N₁₂, N₃, and N₁₃-N₁₄) with endpoint nodes N₁₁ and N₁₄, and a linestring 706 (defined by interconnected nodes N₁₅-N₁₆, N₉, and N₁₇-N₁₉) with endpoint nodes N₁₅ and N₁₉. In this example, the illustrated geospatial dataset may correspond to a region on a map that was selected by a user, via client station 104E, using a front-end application provided by asset data platform 102. Asset data platform 102 may have received from client station 104E data indicative of the user's selected region and identified the illustrated geospatial dataset as a result, which then served as the basis for asset data platform 102 to identify the initial geospatial dataset for evaluation.

For instance, FIG. 7B provides a conceptual illustration of an initial geospatial dataset representing a particular operating environment 710. As illustrated, asset data platform 102 identified for evaluation an initial geospatial dataset comprising linestring 702 (defined by interconnected nodes N₁-N₁₀), which may have resulted from asset data platform 102 determining, for instance, that particular assets of interest traverse a railway corresponding to linestring 702 but do not traverse railways corresponding to linestrings 704 and 706. In other words, asset data platform 102 determined that linestring 702 defines part of an operating environment of interest for certain assets, whereas linestrings 704 and 706 do not. Other examples of asset data platform 102 identifying an initial geospatial dataset also exist.

In some implementations, such as in implementations that involve “whitelist” functions (discussed below), nodes N₃ and N₉ may be flagged as nodes that cannot be eliminated because they correspond to locations at which multiple linestrings intersect. Retaining such nodes may be desirable to maintain the fidelity of the network of geospatial data objects in the initial geospatial dataset. However, in other implementations, maintaining this fidelity may not be important, in which case, nodes N₃ and N₉ may be candidates for removal.

Returning to FIG. 6, at block 604, asset data platform 102 may associate each of at least a plurality of the nodes in the initial geospatial dataset with a respective asset dataset having at least one value of a given asset data variable (e.g., asset speed, fuel consumption, etc.) that is related to how assets typically operate when located in proximity to that node. In practice, the associated asset dataset for a node may include a respective value for multiple asset data variables.

The one or more asset data variables that make up a node's asset dataset may take various forms. As one example, the one or more asset data variables may include one or more operating data variables for assets located in proximity to the given node, examples of which may include a data variable indicating a typical speed of assets located in proximity to that node, a data variable indicating a typical fuel level of assets located in proximity to that node, a data variable indicating a typical fuel consumption rate of assets located in proximity to that node, a data variable indicating a typical RPM measurement or other acceleration rate of assets located in proximity to that node, a data variable indicating a typical payload of assets located in proximity to that node, a data variable indicating a typical gear position of assets located in proximity to that node, a data variable indicating a typical number of gear shifts by assets located in proximity to that node, a data variable indicating a typical internal temperature of assets located in proximity to that node, etc. As another example, the one or more asset data variables may include weather data variables that have a bearing on the operation of assets located in proximity to the given node, examples of which may include a data variable indicating a typical ambient temperature in proximity to that node, a data variable indicating a typical humidity in proximity to that node, a data variable indicating a typical wind speed in proximity to that node, etc. Other types of asset data are possible as well.

In practice, prior to or as part of block 604, asset data platform 102 may perform certain pre-processing functions. For instance, in some implementations, asset data platform 102 may identify raw data of a given asset data variable that corresponds to one or more locations that are considered to be proximate to a given node in the initial geospatial dataset. As one example, asset data platform 102 may identify sensor measurements that are indicative of asset speeds when assets traversed or otherwise operated within a threshold distance (e.g., 5 meters) to a particular node from the initial geospatial dataset. As another example, asset data platform 102 may identify weather measurements that are indicative of a weather condition (e.g., ambient temperature, air pressure, humidity, wind direction, wind speed, etc.) that existed at a given instance of time at a location within a threshold distance (e.g., 20 meters) to a particular node from the initial geospatial dataset. Other examples are also possible.

In some embodiments, asset data platform 102 may then associate nodes in the initial geospatial dataset with raw asset data for one or more asset data variables. However, in other embodiments, asset data platform 102 may perform another pre-processing function based on the identified raw asset data before associating nodes with asset datasets. For instance, based on the identified raw asset data for a given node from the initial geospatial dataset, asset data platform 102 may derive aggregated asset data for the given node and then utilize that asset data for association with the given node.

In practice, aggregated asset data of a particular asset data variable for a given node may provide one or more representative values of the raw asset data of the particular asset data variable that are typical of how assets operate when located in proximity to that node. To that end, asset data platform 102 may derive aggregated asset data by performing one or more statistical evaluations of the identified raw asset data for a given node, such as by determining the mean, median, mode, etc. of the raw asset data. Additionally, or alternatively, asset data platform 102 may derive aggregated asset data by determining one or more probability distributions and/or one or more frequency distributions based on the raw asset data. Other examples are also possible.

Consequently, the respective value for each asset data variable may take a variety of forms. As one example, an asset data variable's respective value may take the form of a discrete data value that is derived from the individual data values (e.g., raw data values) captured for the asset data variable, such as an average of the individual speed values captured for assets located in proximity to a node. In another example, an asset data variable's respective value may take the form of a probability distribution of the individual data values captured for the asset data variable, such as a distribution of the individual speed values captured for assets located in proximity to a node. In yet another example, an asset data variable's respective value may take the form of one or more time-dependent data values (or a distribution of values) that are derived from the individual data values captured for the asset data variable, which may be specific to a particular time of day, a particular time of year, or the like, such as an average ambient temperature at a node during a particular window of time (e.g., a block of hours during which assets typically traverse a railway). In yet other examples, an asset data variable's respective value may take the form of an array of one or more of the aforementioned value forms. Other examples are also possible.

In practice, the respective set of possible values for each asset data variable could take any of a variety of styles, examples of which may include numerical values (e.g., 50° Fahrenheit), ordinal values (e.g., a value indicating temperature on a 1-5 scale), categorical values (e.g., “frozen,” “cold,” “neutral,” “hot,” “boiling”), or the like. In this respect, to the extent that a given asset data variable has a non-numerical value, asset data platform 102 may be configured to convert a non-numerical data value into a numerical value for subsequent functions in the simplification process.

In any event, asset data platform 102 may associate a node with an asset dataset in various manners. As one possibility, asset data platform 102 may perform this association on a node-by-node basis, in which case asset data platform 102 may assign each of the plurality of nodes its own node-specific asset dataset. As another possibility, asset data platform 102 may perform this association for a larger geospatial area that contains multiple nodes, in which case asset data platform 102 may then assign the asset dataset for the larger geospatial area to each node located in that area. Asset data platform 102 may associate a node with an asset dataset in other manners as well.

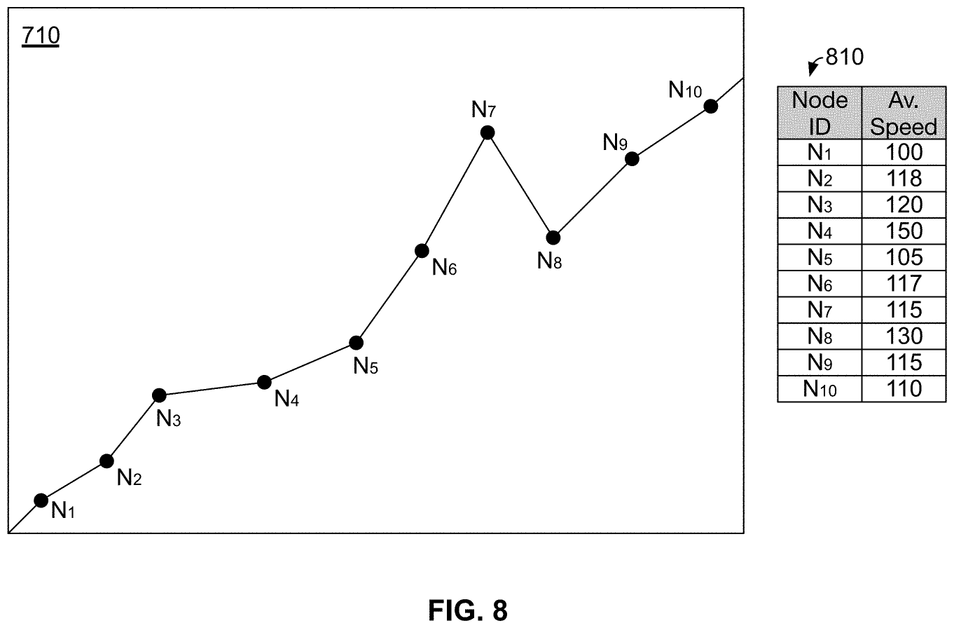

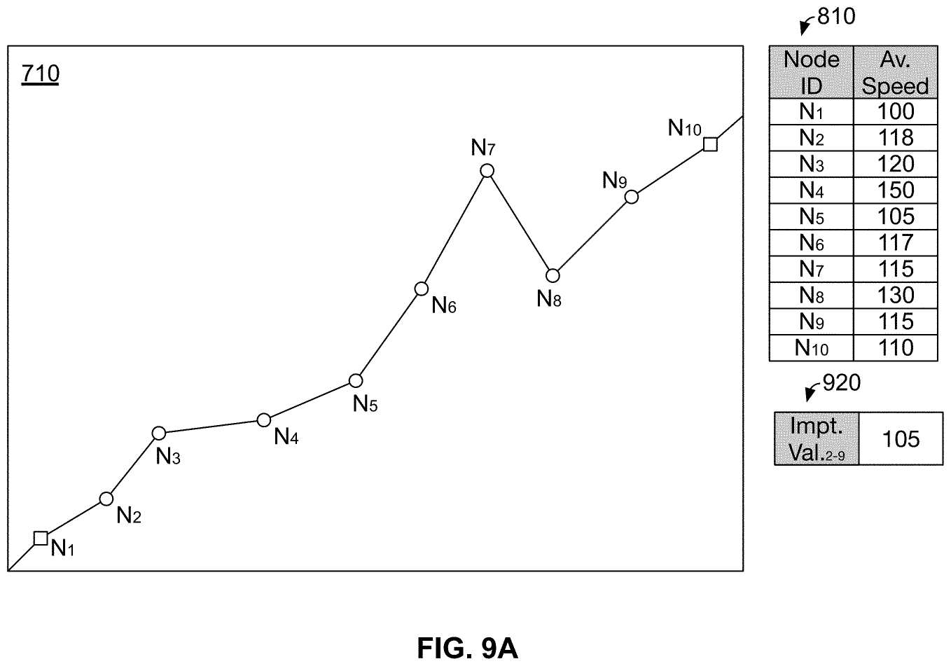

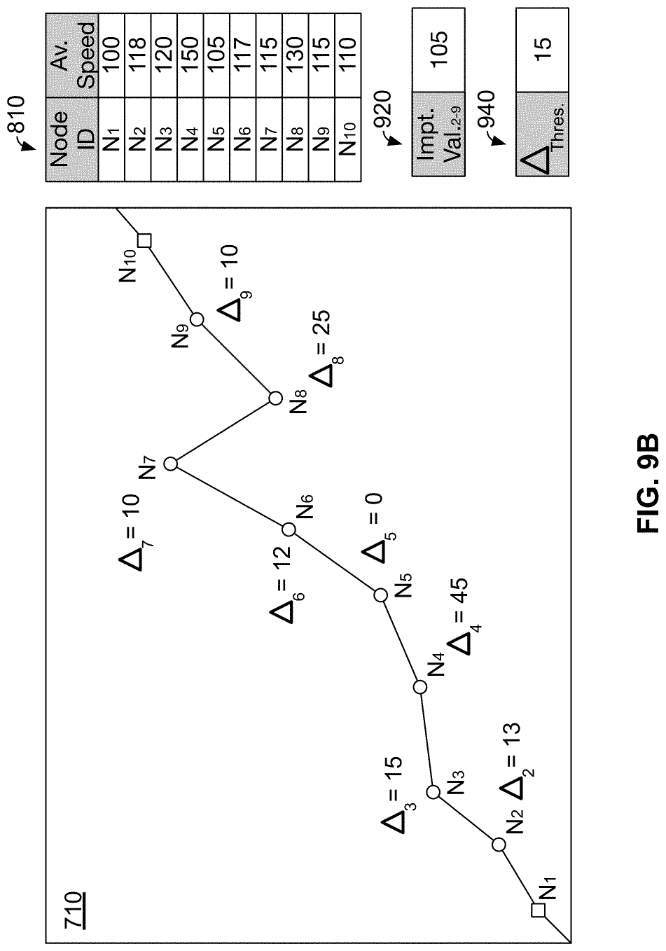

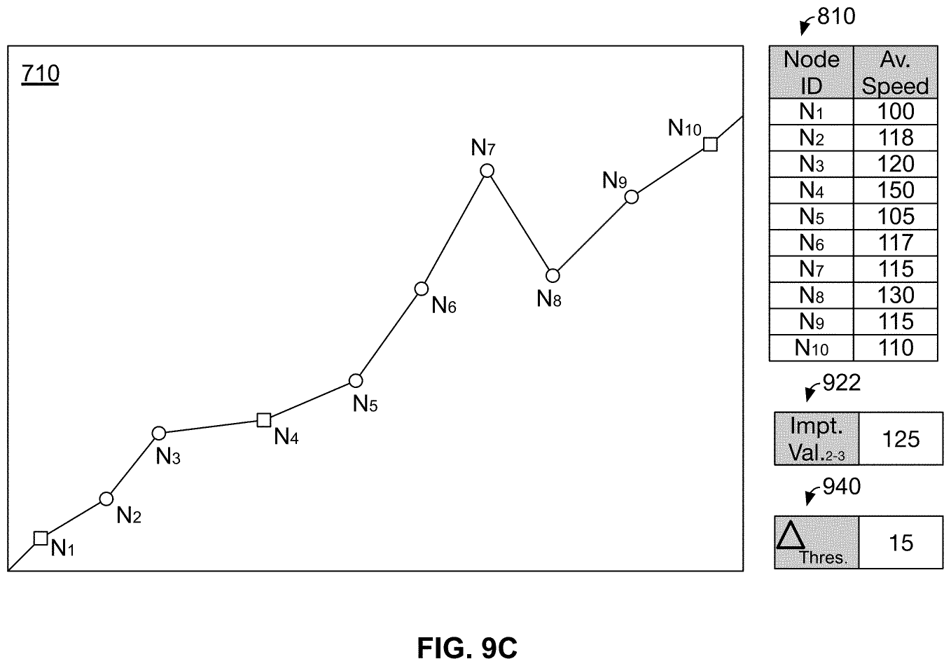

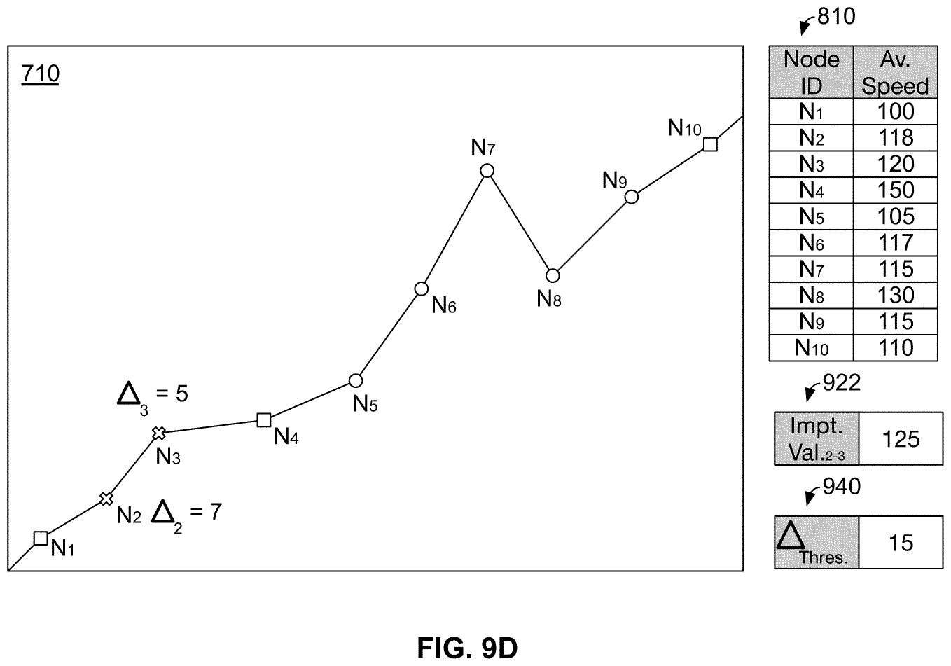

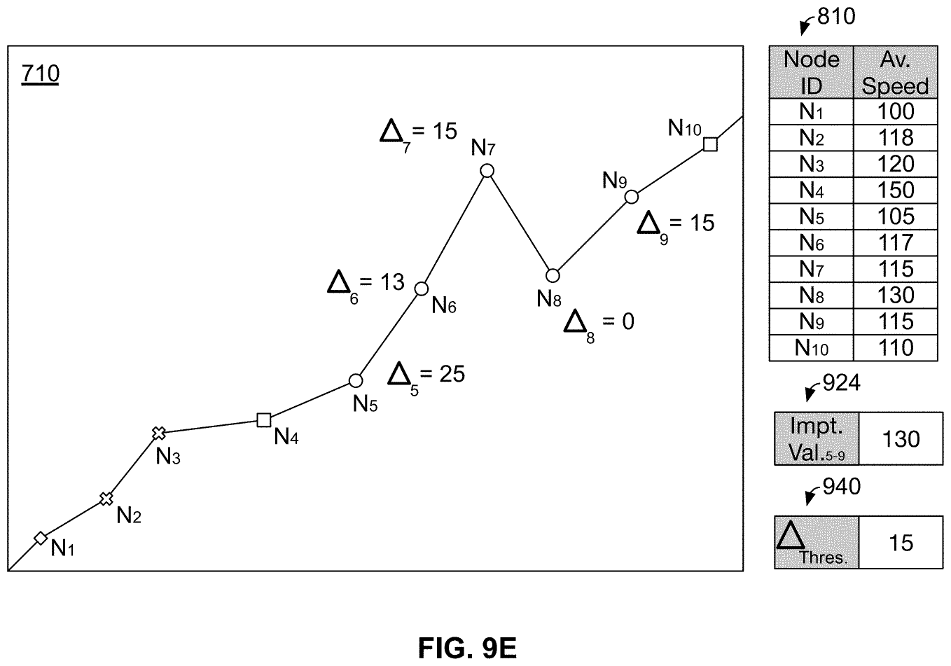

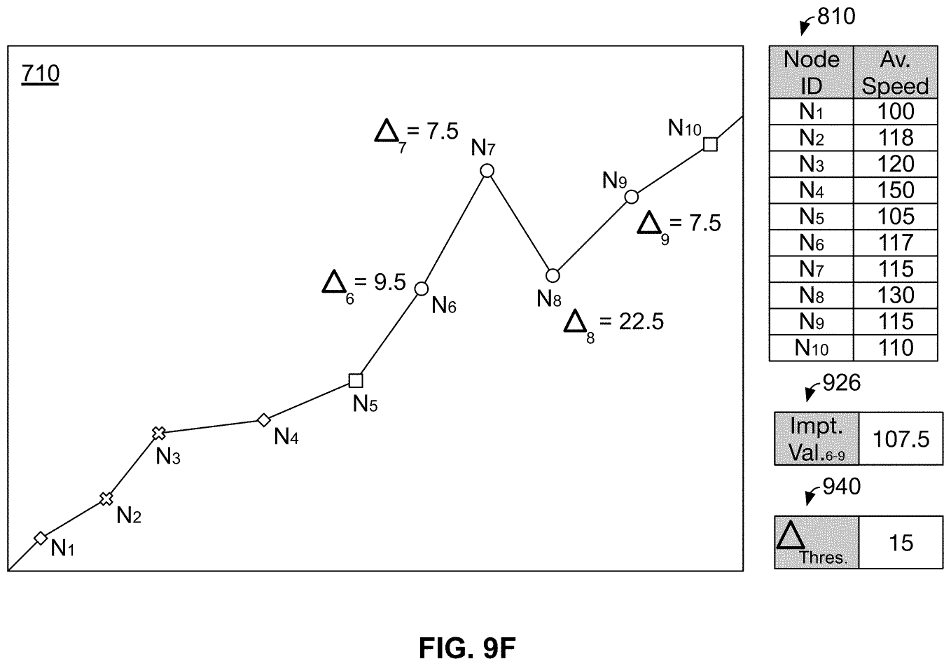

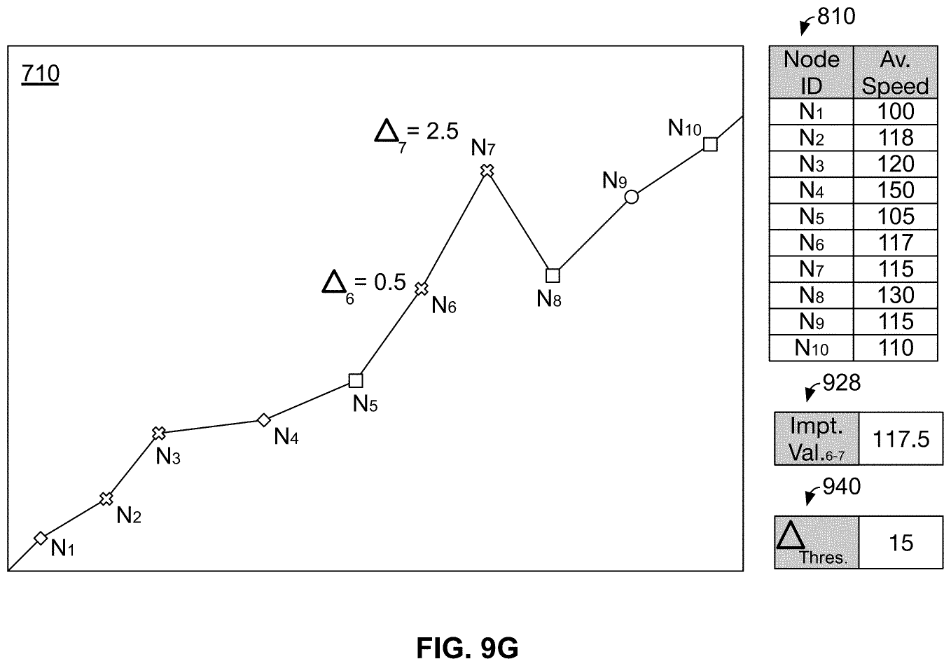

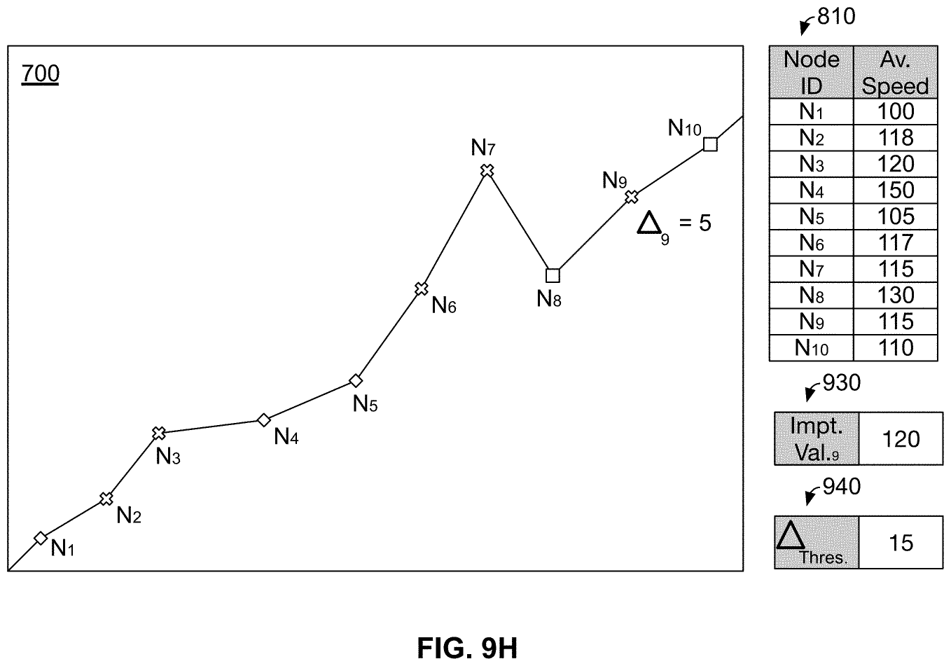

To illustrate, FIG. 8 provides a conceptual illustration of nodes of an initial geospatial dataset that have been associated with asset data. In particular, FIG. 8 includes the initial geospatial dataset representing the particular operating environment 710 from FIG. 7B and a data table 810 of asset data that has been associated with the nodes of the initial geospatial dataset. As shown, data table 810 illustrates an example where asset data platform 102 associated each node of linestring 702 with an asset dataset comprising one asset data variable (e.g., asset speed) whose value was derived to reflect an average speed of assets located in proximity to a given node of linestring 702. For sake of clarity, the reference numeral for linestring 702 has been omitted from FIGS. 8 and 9A-9H.

After asset data platform 102 has associated at least a subset of nodes from the initial geospatial dataset with asset data that is indicative of how assets typically operate when located in proximity to those nodes, asset data platform 102 may use this asset data as a basis to identify “non-critical” nodes that can be eliminated from the initial geospatial dataset. Asset data platform 102 may perform this function in a variety of manners.

For instance, at block 606 of FIG. 6, asset data platform 102 may select a candidate linestring from the initial geospatial dataset that is to be evaluated for node reduction. In practice, this candidate linestring may be selected in various manners.

As one possibility, asset data platform 102 may select the candidate linestring based on inputs received by client station 104E or the like that is communicatively coupled with asset data platform 102. For example, a user might operate, via client station 104E, a front-end application provided by asset data platform 102 and enter inputs indicating a selection of a particular line-type feature within the operating environment that is of interest (e.g., a particular road or railway). Client station 104E may then send to asset data platform 102 data indicative of the selected line-type feature, from which asset data platform 102 may identify a linestring corresponding to that line-type feature and designate that linestring the candidate linestring.

As another possibility, each linestring within the initial geospatial dataset under evaluation is a candidate linestring, and asset data platform 102 selects one of these linestrings randomly, deterministically, or in some other manner that allows each linestring to be eventually evaluated.

As yet another possibility, asset data platform 102 may select the candidate linestring based on certain predetermined criteria, such as a threshold number of nodes. For instance, asset data platform 102 may identify any linestrings from within the initial geospatial dataset that include, for example, more than two nodes. Asset data platform 102 may then designate one of those identified linestrings as the candidate linestring. Asset data platform 102 may select the candidate linestring in other manners as well, such as by combining one or more of the aforementioned possibilities.

As an illustrative example, returning to FIG. 8, asset data platform 102 may have selected linestring 702 as the candidate linestring because it included more than two nodes and it was the only linestring within the initial geospatial dataset. However, it might not always be the case that there is only one linestring within the initial geospatial dataset.

For instance, assume that FIG. 7A represents the initial geospatial dataset identified by asset data platform 102 at step 602 of FIG. 6. In that case, asset data platform 102 may have selected linestring 702 as the candidate linestring for a variety of reasons. As one example, asset data platform 102 may have selected linestring 702 as the candidate linestring based on receiving data indicative of a user selection of a line-type feature corresponding to that linestring from client station 104E. As another example, asset data platform 102 may have selected linestring 702 as a first candidate linestring and then selected linestrings 704 and/or 706 as further candidate linestrings during subsequent iterations of the example simplification process illustrated in FIG. 6. Other examples are also possible.

In some implementations, prior to or as part of block 606, asset data platform 102 may perform an optional pre-processing analysis to determine whether there are any nodes in the initial geospatial dataset that are to be kept regardless of the results of the example simplification process of FIG. 6. This pre-processing analysis may take various forms.

In one implementation, asset data platform 102 may be configured to generate a “whitelist” of nodes in the initial geospatial dataset that are ineligible for elimination (i.e., nodes that cannot be “candidate nodes”). In practice, the function of identifying nodes in the initial geospatial dataset to include on the “whitelist” may take various forms. For instance, in some example embodiments, asset data platform 102 may apply a node-specific function to evaluate whether a particular node should be included in the “whitelist.” In other words, a node-specific function defines one or more rules that dictate which nodes cannot be considered for removal from the initial geospatial dataset. For example, one rule may dictate that nodes of one or more particular classifications cannot be removed from the initial geospatial dataset, such as endpoint nodes, edge nodes, or nodes at which multiple linestrings intersect. As another example, one rule may dictate that nodes in the initial geospatial dataset having associated asset data that satisfies certain “whitelist” threshold criteria, which may be directed to one or more asset data variables (e.g., asset speed, asset fuel level, ambient temperature, etc.), cannot be removed. Depending on how the value of each such asset data variable is represented, the threshold criteria may take any of various forms. As yet another example, one rule may dictate that nodes that correspond to one or more topographical features that affect the operation of assets cannot be removed from the initial geospatial dataset, such as nodes that correspond to a radius of curvature in a linestring that exceeds a threshold radius or nodes that correspond to a grade (e.g., slope) that exceeds a threshold steepness. The function of identifying nodes in the initial geospatial dataset to include on the “whitelist” may take other forms as well.

In any event, asset data platform 102 may use this “whitelist” as a basis to exclude nodes from being considered for removal when generating the reduced geospatial dataset. Asset data platform 102 may perform this function in a variety of manners.

As one possibility, asset data platform 102 may use this “whitelist” to divide a linestring from the initial geospatial dataset into segments, where these segments are defined by the removal of any node on the “whitelist” from the linestring. Asset data platform 102 may then consider each resulting segment of the linestring as a potential candidate linestring for evaluation.

To illustrate, returning to FIG. 7B, asset data platform 102 may have included nodes N₃ and N₇ on the “whitelist” based on certain characteristics of those nodes and/or the asset data associated with them and a particular node-specific function. Asset data platform 102 may then split linestring 702 into segments based on the removal of these nodes. In particular, asset data platform 102 may generate a first linestring segment defined by interconnected nodes N₁-N₃, a second linestring segment defined by interconnected nodes N₃-N₇, and a third linestring segment defined by interconnected nodes N₇-N₁₀. Asset data platform 102 may then evaluate whether any of these linestring segments can be a candidate linestring.

It will become apparent to one of ordinary skill in the art that asset data platform 102 applying this “whitelist” function at this stage of the simplification process, as opposed to a later stage, may be advantageous. Indeed, applying this “whitelist” function as part of or prior to block 608 may be more efficient in regard to the amount of computations that are performed by asset data platform 102 during the simplification process than if it were performed at a later stage. Other advantages are also possible.

Returning to FIG. 6, at blocks 608-610, asset data platform 102 iteratively assigns at least one imputed value of the given asset data variable to one or more candidate nodes of the candidate linestring and executes a divergence function based thereon that evaluates whether any of those candidate nodes from the candidate linestring can be removed without causing a significant loss of fidelity with respect to the associated asset dataset.

With respect to block 608, asset data platform 102 may assign at least one imputed value of the given asset data variable to one or more candidate nodes of the candidate linestring in a variety of manners. As one possibility, this function may involve asset data platform 102 first identifying at least two imputation nodes in the candidate linestring that are to be used to impute a value of the given asset data variable for each other node in the linestring that is to be evaluated for elimination. The imputation nodes can be identified in a variety of manners.

As one possibility, asset data platform 102 may identify the endpoint nodes of the candidate linestring as the imputation nodes for the candidate linestring. As another possibility, the data analytics platform may designate at least one node that has been previously designated for retainment—which may have been so designated based on a prior iteration of blocks 608-610—as one of the imputation nodes for the candidate linestring. Other examples of identifying the imputation nodes are also possible.

Based on the imputation nodes' respective values of the given asset data variable, asset data platform 102 may then assign a respective imputed value of the given asset data variable to each candidate node of the candidate linestring (e.g., each intermediate node of the candidate linestring), where the respective imputed value of the given asset data variable for a given candidate node represents a value of the given asset data variable at the given candidate node's location along the candidate linestring in a scenario where the candidate node is eliminated. Asset data platform 102 may carry out this operation in various manners.

As one possibility, asset data platform 102 may use the imputation nodes' respective values of the given asset data variable to determine a single imputed value of the given asset data variable for the candidate linestring and then assign that single imputed value to each candidate node in the candidate linestring. For example, asset data platform 102 may determine a single imputed value (e.g., a mean, median, etc. value) from the imputation nodes' respective values of the given asset data variable. The single imputed value may take other forms and be determined in other manners as well.

As another possibility, asset data platform 102 may determine, based at least on the imputation nodes' respective values of the given asset data variable, an imputed value of the given asset data variable on a node-by-node basis for each candidate node, such that each candidate node is assigned its own individual imputed value. For instance, based on the imputation nodes' respective values of the given asset data variable and a candidate node's relative location within the candidate linestring, asset data platform 102 may interpolate an imputed value of the given asset data variable for the candidate node. Asset data platform 102 may use the imputation nodes' respective values of the given asset data variable to assign a respective imputed value of the given asset data variable to each candidate node of the candidate linestring in other manners as well.

In any event, as a result of asset data platform 102 assigning a respective imputed value of the given asset data variable to each candidate node of the candidate linestring, the candidate linestring will then have two sets of values of the given asset data variable: (i) a first set that includes each candidate node's respective original value of the given asset data variable and (ii) a second set that includes each candidate node's respective imputed value of the given asset data variable.

As an illustrative example, FIG. 9A provides a conceptual illustration of certain aspects of functions related to block 608. In particular, FIG. 9A includes the initial geospatial dataset representing the particular operating environment 710 from FIG. 7B and data table 810 of associated asset data from FIG. 8. Moreover, FIG. 9A depicts that asset data platform 102 determined a single imputed value 920 for candidate nodes N₂-N₉ of the candidate linestring 702. In this example, asset data platform 102 determined this imputed value by first identifying imputation nodes N₁ and N₁₀, which it did by identifying the endpoints of the candidate linestring since this was the first iteration of blocks 608-610 of FIG. 6. Next, asset data platform 102 determined imputed value 920 for candidate nodes N₂-N₉ by determining the mean value of imputation nodes N₁'s and N₁₀'s respective average asset speed values (e.g., the mean of 100 and 110 MPH is 105 MPH). Notably, the imputation nodes are signified in FIG. 9A by square symbols to contrast them from the nodes that are candidates for removal, which are signified by empty circle symbols.

Returning to FIG. 6, at block 610, asset data platform 102 may execute a divergence function based on the at least one imputed value of the given asset data variable assigned to the one or more candidate nodes of the candidate linestring and the original values of the asset data associated with the one or more candidate nodes of the candidate linestring. In particular, asset data platform 102 inputs these two sets of values into a divergence function, which may in turn determine and output a maximum divergence between the original and imputed values of the given asset data variable.

At a high level, the divergence function may make this determination by calculating a respective divergence between the original and imputed values of the given asset data variable for each candidate node and then identifying the largest of these respective divergence values. However, the divergence function may determine the maximum divergence in other manners as well.

To illustrate, FIG. 9B provides a conceptual illustration of certain aspects of functions related to block 610. As shown, FIG. 9B builds on FIG. 9A by including divergence values for each candidate node N₂-N₉ that were determined by calculating the difference between each candidate node's original average speed value (e.g., as set forth in data table 810) and imputed value 920. For instance, calculating the difference between node N₂'s original average speed value (118 MPH) and imputed value 920 (105 MPH) yields a divergence of 13 MPH. After performing a similar calculation for nodes N₃-N₉, asset data platform 102 determined that node N₄'s divergence is the maximum divergence.

In practice, a divergence function can take a variety of forms. In some implementations, the divergence function may be symmetric such that the divergence from the original value to the imputed value is equivalent to the divergence from the imputed value to the original value. In other implementations, the divergence function may be asymmetric such that the divergence from the original value to the imputed value is different from the divergence from the imputed value to the original value. Thus, a divergence function could be applied to the original and imputed values of the given asset data variable in different ways.

Once the maximum divergence between the original and imputed values of the given asset data variable has been determined, asset data platform 102 may compare the maximum divergence to a threshold value that serves as a dividing line between a loss of fidelity for the given asset data variable that is acceptable and a loss of fidelity for the given asset data variable that is not acceptable. In practice, the threshold value may be predefined by asset data platform 102 or perhaps defined by a user via inputs provided at client station 104E. In some instances, the threshold value may be defined based on the particular asset data variable that is under evaluation. For instance, the magnitude of the threshold value for one asset data variable (e.g., asset speed) may differ from the magnitude of the threshold value for another asset data variable (e.g., asset ambient temperate). In some cases, asset data platform 102 may utilize multiple threshold values, which in some instances might be dependent on one or more characteristics of the particular intermediate node under evaluation. Other examples are also possible.

Based on comparing the maximum divergence to the threshold, asset data platform 102 may determine either (i) that the maximum divergence is at or below the threshold, in which case elimination of all candidate nodes in the candidate linestring would result in a loss of fidelity for the given asset data variable that is acceptable or (ii) that the maximum divergence exceeds the threshold, in which case elimination of all candidate nodes in the candidate linestring would result in a loss of fidelity for the given asset data variable that is not acceptable.

If the maximum divergence value is at or below the threshold, asset data platform 102 may designate each candidate node in the linestring as a “non-critical” node that can be eliminated. In which case, only the imputation nodes of the candidate linestring (e.g., the endpoint nodes) are designated “critical” nodes and thus retained. At that point, asset data platform 102 may consider the evaluation to be completed for the current candidate linestring and may select another candidate linestring in the initial geospatial dataset to evaluate (to the extent there are other linestrings in the initial geospatial dataset that are still eligible for evaluation). Notably, in FIGS. 9A-9H, “critical” nodes that have been designated for retainment are signified by a diamond symbol, whereas “non-critical” nodes that have been designated for removal are signified by a “X” symbol.

On the other hand, if the maximum divergence exceeds the threshold—which indicates that elimination of all candidate nodes in the candidate linestring would result in an unacceptable loss of fidelity for the given asset data variable—asset data platform 102 may evaluate whether less than all candidate nodes in the candidate linestring can be eliminated. Returning to the example of FIG. 9B, the maximum divergence of 45 MPH for node N₄ exceeds example threshold value 940 (e.g., 15 MPH). Accordingly, asset data platform 102 carries out this evaluation for the candidate linestring 702.

In practice, asset data platform 102 may evaluate whether less than all candidate nodes in the candidate linestring can be eliminated in various manners. As one possible example, asset data platform 102 may (i) identify the node in the candidate linestring that corresponds to the maximum divergence (e.g., node N₄ in FIG. 9B), (ii) break the candidate linestring into two segments that intersect at the identified node (i.e., the identified node becomes an endpoint node for the two segments), (iii) for a segment that has only two nodes, determine that no nodes can be eliminated (i.e., those two nodes are designated “critical”), and (iv) for a segment that has more than two nodes, recursively perform the foregoing process to evaluate whether any node(s) in the segment can be eliminated (i.e., repeat blocks 608-610 with the node corresponding to the maximum divergence serving as an imputation node). Once this evaluation has been completed, asset data platform 102 may then select another candidate linestring in the initial geospatial dataset to evaluate (to the extent there are other linestrings in the initial geospatial dataset that are still eligible for evaluation).

In some embodiments, instead of the divergence function outputting a maximum divergence and then asset data platform 102 determining the criticality of candidate notes based on the maximum divergence, the divergence function may output a different metric that is used for the determination. For example, the divergence function may output an average divergence for the intermediate nodes under evaluation and this average divergence might then be compared to a threshold value that serves as a dividing line between a loss of fidelity for the given asset data variable that is acceptable and a loss of fidelity for the given asset data variable that is not acceptable, in accordance with the above discussion. Other possible divergence metrics also exist.

In some implementations in which the asset data variable's respective value takes the form of a probability or frequency distribution, the aforementioned example simplification process may involve determining an average (e.g., a weighted average), or some other measure, of the distributions from the imputation nodes and then applying a divergence function to that determined measure along with the distribution for an intermediate node under evaluation. In some such cases, the divergence function may be configured to determine the Kullback-Leibler divergence, the earthmover's distance, and/or some other measure of similarity between these two distributions. Other possibilities may also exist.

In any event, FIGS. 9C-9H provide conceptual illustrations of certain aspects of this iterative process for the example candidate linestring 702. For instance, after executing the first iteration of the divergence function and determining that the maximum divergence of 45 MPH for node N₄ exceeds threshold value 940, asset data platform 102 determined that node N₄ was a new imputation node.

Next, as shown in FIG. 9C, asset data platform 102 identified imputation nodes N₁, N₄, and N₁₀ (signified by the square symbols) and assigned a single imputed value 922 to candidate nodes N₂-N₃ of the segment of candidate linestring 702 that is defined by imputation nodes N₁ and N₄. In this example, asset data platform 102 determined imputed value 922 by determining the mean value of imputation nodes N₁'s and N₄'s respective average asset speed values (e.g., the mean of 100 and 150 MPH is 125 MPH).

Thereafter, as shown in FIG. 9D, asset data platform 102 determined divergence values for candidate nodes N₂-N₃ by calculating the difference between these node's respective original average speed values (e.g., as set forth in data table 810) and imputed value 922. In the illustrated example, asset data platform 102 determined that node N₂'s divergence was the maximum divergence. However, asset data platform 102 determined that this maximum divergence (7 MPH) was below threshold value 940 (15 MPH) and consequently designated candidate nodes N₂-N₃ as “non-critical” nodes that can be eliminated (signified in FIG. 9D by the “X” symbols).

Then, as shown in FIG. 9E, asset data platform 102 returned to imputation nodes N₁, N₄, and N₁₀ and assigned a single imputed value 924 for candidate nodes N₅-N₉ of the segment of candidate linestring 702 that is defined by imputation nodes N₄ and N₁₀. In this example, asset data platform 102 determined imputed value 924 by determining the mean value of imputation nodes N₄'s and N₁₀'s respective average asset speed values (e.g., the mean of 150 and 110 MPH is 130 MPH). Asset data platform 102 then determined divergence values for candidate nodes N₅-N₉ by calculating the difference between these nodes' respective original average speed values and imputed value 924. In the illustrated example, asset data platform 102 determined that node N₅'s divergence was the maximum divergence and because node N₅'s divergence value exceeded threshold value 940 (e.g., 25 MPH is greater than 15 MPH), node N₅ was designated an imputation node for a subsequent iteration of blocks 608-610, which is illustrated in FIG. 9F.

As shown in FIG. 9F, asset data platform 102 identified imputation nodes N₅ and N₁₀ and assigned a single imputed value 926 to candidate nodes N₆-N₉ of the segment of candidate linestring 702 that is defined by imputation nodes N₅ and N₁₀. In this example, asset data platform 102 determined imputed value 926 by determining the mean value of imputation nodes N₅'s and N₁₀'s respective average asset speed values (e.g., the mean of 105 and 110 MPH is 107.5 MPH). Asset data platform 102 determined divergence values for candidate nodes N₆-N₉ by calculating the difference between these nodes' respective original average speed values and imputed value 926. In the illustrated example, asset data platform 102 determined that node N₈'s divergence value was the maximum divergence, and because node N₈'s divergence value exceeded threshold value 940 (e.g., 22.5 MPH is greater than 15 MPH), node N₈ was designated an imputation node for a subsequent iteration of blocks 608-610, which is illustrated in FIG. 9G.

As shown in FIG. 9G, asset data platform 102 identified imputation nodes N₅, N₈, and N₁₀ and assigned a single imputed value 928 to candidate nodes N₆-N₇ of the segment of candidate linestring 702 that is defined by imputation nodes N₅ and N₈. In this example, asset data platform 102 determined imputed value 928 by determining the mean value of imputation nodes N₅'s and N₈'s respective average asset speed values (e.g., the mean of 105 and 130 MPH is 117.5 MPH). Asset data platform 102 determined divergence values for candidate nodes N₆-N₇ by calculating the difference between these nodes' respective original average speed values and imputed value 928. In the illustrated example, asset data platform 102 determined that node N₇'s divergence was the maximum divergence, and because node N₇'s divergence value did not exceed threshold value 940 (e.g., 2.5 MPH is less than 15 MPH), nodes N₆-N₇ were designated as “non-critical” nodes that can be eliminated (signified in FIG. 9G by the “X” symbols).

Thereafter, as shown in FIG. 9H, asset data platform 102 returned to the identified imputation nodes N₅, N₈, and N₁₀ and assigned a single imputed value 930 for candidate node N₉, which is the only candidate node in the segment of candidate linestring 702 that is defined by imputation nodes N₈ and N₁₀. In this example, asset data platform 102 determined imputed value 930 by determining the mean value of imputation nodes N₈'s and N₁₀'s respective average asset speed values (e.g., the mean of 130 and 110 MPH is 120 MPH). Asset data platform 102 determined a divergence value for candidate node N₉ by calculating the difference between this node's original average speed value (e.g., 115 MPH) and imputed value 930. In the illustrated example, asset data platform 102 determined that node N₉'s divergence was the maximum divergence (because it was the only candidate node), and then designated node N₉ as a “non-critical” node that can be eliminated because this divergence value did not exceed threshold value 940 (e.g., 5 MPH is less than 15 MPH). After asset data platform 102 designated node N₉ as a “non-critical” node, asset data platform 102's evaluation of candidate linestring 702 was finished. It may then select another candidate linestring in the initial geospatial dataset to evaluate (to the extent there are other linestrings in the geospatial dataset that are still eligible for evaluation).

Returning to FIG. 6, at block 612, asset data platform 102 may generate a reduced geospatial dataset as a result of evaluating one or more linestrings from the initial geospatial dataset using the process set forth in blocks 602-610. For instance, as a result of the foregoing functions, asset data platform 102 may have identified a set of “non-critical” nodes in the initial geospatial dataset that have been flagged for elimination.

In example embodiments, asset data platform 102 may then proceed to eliminate each of the identified “non-critical” nodes from the initial geospatial dataset, thereby generating a reduced geospatial dataset. As an illustrative example, FIG. 7C provides a conceptual illustration of a reduced geospatial dataset representing a simplified operating environment 720. As shown, the reduced geospatial dataset includes a simplified linestring 722 defined by nodes N₁, N₄, N₅, N₈, and N₁₀, which make up the reduced geospatial dataset that results from applying the simplification process of FIG. 6 to linestring 702 of FIG. 7B. Comparing FIG. 7C to FIG. 7B, one will appreciate that the aforementioned simplification process helps to eliminate half of the data nodes but retains nodes corresponding to asset data of interest.

Notably, in some implementations, whether identified “non-critical” nodes are eliminated from the initial geospatial dataset may depend on the computations asset data platform 102 intends to perform on the reduced geospatial dataset. In this respect, a particular node identified as being “non-critical” may be eliminated when asset data platform 102 is utilizing the reduced geospatial dataset for a particular purpose but may not be eliminated when asset data platform 102 is utilizing the reduced geospatial dataset for a different purpose. For example, asset data platform 102 may be set to perform a simulation based on the reduced geospatial dataset, in which case identified “non-critical” nodes that are deemed “vertices” may not be eliminated when the reduced geospatial dataset is generated. Other examples are also possible.

In some embodiments, before generating the reduced geospatial dataset, asset data platform 102 may be configured to optionally perform, after block 610, the function of applying a “whitelist” (discussed above with reference to block 606) to the nodes in the initial geospatial dataset that were designated for elimination. In this respect, asset data platform 102 may consult the “whitelist” to determine whether any of the nodes that were flagged for elimination using the foregoing process should nevertheless be kept. In practice, this embodiment may be an alternative to an embodiment that implements “whitelist” functionality prior to or as part of block 606.

In any event, after asset data platform 102 completes the simplification process and generates a reduced geospatial dataset by removing nodes designated for elimination, asset data platform 102 may use this reduced dataset to perform certain computing tasks in a more efficient and/or optimal manner than if it were performing those computing tasks using the initial geospatial dataset. Indeed, in line with the above discussion, the reduced geospatial dataset may enable asset data platform 102 to expend fewer compute resources than if it were using the initial geospatial dataset and may also help to reduce data storage requirements of asset data platform 102 and/or computational strain on asset data platform 102.

As discussed before, an example computing task that asset data platform 102 may be able to perform more efficiently based on at least the reduced geospatial dataset may involve creating and/or executing a computer simulation of asset operation in an operating environment defined by the reduced geospatial dataset. One example framework for creating and executing a computer simulation of asset operation in an operating environment is described in U.S. application Ser. No. 16/009,601, which is incorporated by reference herein in its entirety.

As another example computing task that asset data platform 102 may be able to perform more efficiently based on at least the reduced geospatial dataset, asset data platform 102 may perform image analytics for an operating environment defined by the reduced geospatial dataset. In yet another example, asset data platform 102 may, based on at least the reduced geospatial dataset, more efficiently monitor the real-world movement of an asset (e.g., asset 104A) through an operating environment represented by the reduced geospatial dataset, among other examples.

Moreover, the disclosed simplification process may provide various other advantages as well. As one possibility, asset data platform 102 may output at an output system 106, such as at client station 106A, recommendations regarding placement and/or maintenance of asset-environment sensors that are distributed in a real-world geographic region based on the results of the disclosed simplification process. For instance, asset data platform 102 can utilize the disclosed simplification process to identify “critical” locations in the operating environment at which asset-environment sensors (e.g., wayside sensors on a railway) should be placed. On the other hand, asset data platform 102 can utilize the disclosed simplification process to identify “non-critical” locations in the operating environment at which previously placed asset-environment sensors can be removed or allowed to fall out of service. In any event, asset data platform 102 can cause an output system 106 to output recommendations or the like in accordance with its identification of “critical”/“non-critical” geographic locations.

As another possibility, a local analytics device of an asset may be configured to apply the simplification process to geospatial data that is being captured “on the fly” by assets as they move through an operating environment, which may help to reduce the compute resources necessary to process and store such a geospatial dataset at the asset as well as the network resources required to transmit such a geospatial dataset from the asset to another data analytics platform.

For instance, the local analytics device may be configured to generate or otherwise obtain a set of environmental data (e.g., geospatial data) or the like “on the fly” as the asset travels through an environment. The local analytics device may be configured to determine “on the fly” that the set of data eventually constitutes or otherwise comprises a candidate linestring. The local analytics device then employs the aforementioned simplification process to that candidate linestring, which may result in a reduced dataset for that candidate linestring. The local analytics device may then take some action with that reduced dataset, such as transmitting it to a remote system (e.g., asset data platform 102) and/or storing the reduced dataset in local storage, among other possible actions.

The disclosed simplification process may provide other advantages and/or enable other functions as well.

### V. CONCLUSION

Example embodiments of the disclosed process have been described above. Those skilled in the art will understand, however, that changes and modifications may be made to the embodiments described without departing from the true scope and sprit of the present invention, which will be defined by the claims.

Further, to the extent that examples described herein involve operations performed or initiated by actors, such as “humans,” “operators,” “users” or other entities, this is for purposes of example and explanation only. The claims should not be construed as requiring action by such actors unless explicitly recited in the claim language.

We claim:

1. A computing system comprising:
at least one processor;
a non-transitory computer-readable medium; and
program instructions stored on the non-transitory computer-readable medium that are executable by the at least one processor to cause the computing system to:
identify an initial dataset that is representative of a given environment in which assets operate, wherein the initial dataset comprises a plurality of linestrings each having at least two nodes;
associate each of a plurality of nodes with a respective set of asset data that is related to how assets operate when located in proximity to the node, wherein the respective set of asset data for each of the plurality of nodes comprises a respective value of at least one given asset data variable;
for each of one or more candidate linestrings in the initial dataset, evaluate whether any one or more candidate nodes in the candidate linestring can be eliminated using a divergence function that operates to determine a maximum divergence between (i) one set of values that includes an original value of the given asset data variable for each of the one or more candidate nodes and (ii) another set of values that includes an imputed value of the given asset data variable for each of the one or more candidate nodes;
based on the evaluation, identify a set of nodes in the initial dataset that can be eliminated;
use the identified set of nodes as a basis to eliminate one or more nodes from the initial dataset and thereby generate a reduced dataset; and
use the reduced dataset to evaluate the operation of assets in the given environment.

2. The computing system of claim 1, wherein the program instructions that are executable by the at least one processor to cause the computing system to evaluate whether any one or more candidate nodes in the candidate linestring can be eliminated using the divergence function comprise program instructions stored on the non-transitory computer-readable medium that are executable by the at least one processor to cause the computing system to:
identify a first set of candidate nodes that includes one or more nodes in the candidate linestring to be evaluated for elimination;
identify a first set of imputation nodes that includes two or more nodes in the candidate linestring to be used to impute a respective value of the given asset data variable for each of the first set of candidate nodes;
use the respective values of the given asset data variable for each of the first set of imputation nodes to assign a respective imputed value of the given asset data variable to each of the first set of candidate nodes;
apply the divergence function to determine a first divergence value that indicates a maximum divergence between (i) one set of values that includes an original value of the given asset data variable for each of the first set of candidate nodes and (ii) another set of values that includes an imputed value of the given asset data variable for each of the first set of candidate nodes;
compare the first divergence value to a threshold; and
based on the comparison, either (i) determine that all of the first set of candidate nodes can be eliminated if the first divergence value does not exceed the threshold or (ii) evaluate whether less than all of the first set of candidate nodes can be eliminated if the first divergence value does exceed the threshold.

3. The computing system of claim 2, wherein the program instructions that are executable by the at least one processor to cause the computing system to evaluate whether less than all of the first set of candidate nodes can be eliminated comprise program instructions stored on the non-transitory computer-readable medium that are executable by the at least one processor to cause the computing system to:
identify a given node in the first set of candidate nodes that is associated with the first divergence value;
break the candidate linestring into two segments that intersect at the given node; and
for any segment that has more than two nodes:
identify a second set of candidate nodes that includes one or more nodes in the segment to be evaluated for elimination;
identify a second set of imputation nodes that includes two or more nodes in the segment to be used to impute a respective value of the given asset data variable for each of the second set of candidate nodes;
use the respective values of the given asset data variable for each of the second set of imputation nodes to assign a respective imputed value of the given asset data variable to each of the second set of candidate nodes;
apply the divergence function to determine a second divergence value that indicates a maximum divergence between (i) one set of values that includes an original value of the given asset data variable for each of the second set of candidate nodes and (ii) another set of values that includes an imputed value of the given asset data variable for each of the second set of candidate nodes;
compare the second divergence value to a threshold; and
based on the comparison, either (i) determine that all of the second set of candidate nodes can be eliminated if the second divergence value does not exceed the threshold or (ii) evaluate whether less than all of the second set of candidate nodes can be eliminated if the second divergence value does exceed the threshold.

4. The computing system of claim 1, wherein the at least one given asset data variable comprises one of (i) a data variable indicating a speed of assets located in proximity to a given node of the plurality of nodes, (ii) a data variable indicating a fuel level of assets located in proximity to the given node of the plurality of nodes, (iii) a data variable indicating a fuel consumption of assets located in proximity to the given node of the plurality of nodes, (iv) a data variable indicating an acceleration measurement of assets located in proximity to the given node of the plurality of nodes, (v) a data variable indicating a payload of assets located in proximity to the given node of the plurality of nodes, (vi) a data variable indicating a gear position of assets located in proximity to the given node of the plurality of nodes, or (vii) a data variable indicating a number of gear shifts by assets located in proximity to the given node of the plurality of nodes.

5. The computing system of claim 1, wherein the at least one given asset data variable comprises one of (i) a data variable indicating an ambient temperature in proximity to a given node of the plurality of nodes or (ii) a data variable indicating a humidity in proximity to the given node of the plurality of nodes.

6. The computing system of claim 1, wherein the program instructions that are executable by the at least one processor further cause the computing system to, before evaluating whether any one or more candidate nodes in the candidate linestring can be eliminated:
identify one or more nodes of the initial dataset that are ineligible to be eliminated based on applying one or more threshold criterion; and
define at least one linestring by removing the identified one or more nodes of the initial dataset that are ineligible to be eliminated, wherein the one or more candidate linestrings in the initial dataset comprises the defined at least one linestring.

7. The computing system of claim 1, wherein the program instructions that are executable to cause the computing system to use the reduced dataset to evaluate the operation of assets in the given environment comprise program instructions that are executable to cause the computing system to one or more of (i) create a computer simulation of the operation of assets in the given environment based on the reduced dataset or (ii) execute a computer simulation of the operation of assets in the given environment based on the reduced dataset.

8. A non-transitory computer-readable medium comprising program instructions that are executable to cause a computing system to:
identify an initial dataset that is representative of a given environment in which assets operate, wherein the initial dataset comprises a plurality of linestrings each having at least two nodes;
associate each of a plurality of nodes with a respective set of asset data that is related to how assets operate when located in proximity to the node, wherein the respective set of asset data for each of the plurality of nodes comprises a respective value of at least one given asset data variable;
for each of one or more candidate linestrings in the initial dataset, evaluate whether any one or more candidate nodes in the candidate linestring can be eliminated using a divergence function that operates to determine a maximum divergence between (i) one set of values that includes an original value of the given asset data variable for each of the one or more candidate nodes and (ii) another set of values that includes an imputed value of the given asset data variable for each of the one or more candidate nodes;
based on the evaluation, identify a set of nodes in the initial dataset that can be eliminated;
use the identified set of nodes as a basis to eliminate one or more nodes from the initial dataset and thereby generate a reduced dataset; and
use the reduced dataset to evaluate the operation of assets in the given environment.

9. The computer-readable medium of claim 8, wherein the program instructions that are executable to cause the computing system to evaluate whether any one or more candidate nodes in the candidate linestring can be eliminated using the divergence function comprise program instructions that are executable to cause the computing system to:
identify a first set of candidate nodes that includes one or more nodes in the candidate linestring to be evaluated for elimination;
identify a first set of imputation nodes that includes two or more nodes in the candidate linestring to be used to impute a respective value of the given asset data variable for each of the first set of candidate nodes;
use the respective values of the given asset data variable for each of the first set of imputation nodes to assign a respective imputed value of the given asset data variable to each of the first set of candidate nodes;
apply the divergence function to determine a first divergence value that indicates a maximum divergence between (i) one set of values that includes an original value of the given asset data variable for each of the first set of candidate nodes and (ii) another set of values that includes an imputed value of the given asset data variable for each of the first set of candidate nodes;
compare the first divergence value to a threshold; and
based on the comparison, either (i) determine that all of the first set of candidate nodes can be eliminated if the first divergence value does not exceed the threshold or (ii) evaluate whether less than all of the first set of candidate nodes can be eliminated if the first divergence value does exceed the threshold.

10. The computer-readable medium of claim 9, wherein the program instructions that are executable to cause the computing system to evaluate whether less than all of the first set of candidate nodes can be eliminated comprise program instructions that are executable to cause the computing system to:
identify a given node in the first set of candidate nodes that is associated with the first divergence value;
break the candidate linestring into two segments that intersect at the given node; and
for any segment that has more than two nodes:
identify a second set of candidate nodes that includes one or more nodes in the segment to be evaluated for elimination;
identify a second set of imputation nodes that includes two or more nodes in the segment to be used to impute a respective value of the given asset data variable for each of the second set of candidate nodes;
use the respective values of the given asset data variable for each of the second set of imputation nodes to assign a respective imputed value of the given asset data variable to each of the second set of candidate nodes;
apply the divergence function to determine a second divergence value that indicates a maximum divergence between (i) one set of values that includes an original value of the given asset data variable for each of the second set of candidate nodes and (ii) another set of values that includes an imputed value of the given asset data variable for each of the second set of candidate nodes;
compare the second divergence value to a threshold; and
based on the comparison, either (i) determine that all of the second set of candidate nodes can be eliminated if the second divergence value does not exceed the threshold or (ii) evaluate whether less than all of the second set of candidate nodes can be eliminated if the second divergence value does exceed the threshold.

11. The computer-readable medium of claim 8, wherein the at least one given asset data variable comprises one of (i) a data variable indicating a speed of assets located in proximity to a given node of the plurality of nodes, (ii) a data variable indicating a fuel level of assets located in proximity to the given node of the plurality of nodes, (iii) a data variable indicating a fuel consumption of assets located in proximity to the given node of the plurality of nodes, (iv) a data variable indicating an acceleration measurement of assets located in proximity to the given node of the plurality of nodes, (v) a data variable indicating a payload of assets located in proximity to the given node of the plurality of nodes, (vi) a data variable indicating a gear position of assets located in proximity to the given node of the plurality of nodes, or (vii) a data variable indicating a number of gear shifts by assets located in proximity to the given node of the plurality of nodes.

12. The computer-readable medium of claim 8, wherein the at least one given asset data variable comprises one of (i) a data variable indicating an ambient temperature in proximity to a given node of the plurality of nodes or (ii) a data variable indicating a humidity in proximity to the given node of the plurality of nodes.

13. The computer-readable medium of claim 8, wherein the program instructions that are executable further cause the computing system to, before evaluating whether any one or more candidate nodes in the candidate linestring can be eliminated:
identify one or more nodes of the initial dataset that are ineligible to be eliminated based on applying one or more threshold criterion; and
define at least one linestring by removing the identified one or more nodes of the initial dataset that are ineligible to be eliminated, wherein the one or more candidate linestrings in the initial dataset comprises the defined at least one linestring.

14. The computer-readable medium of claim 8, wherein the program instructions that are executable to cause the computing system to use the reduced dataset to evaluate the operation of assets in the given environment comprise program instructions that are executable to cause the computing system to one or more of (i) create a computer simulation of the operation of assets in the given environment based on the reduced dataset or (ii) execute a computer simulation of the operation of assets in the given environment based on the reduced dataset.

15. A method comprising:
identifying an initial dataset that is representative of a given environment in which assets operate, wherein the initial dataset comprises a plurality of linestrings each having at least two nodes;
associating each of a plurality of nodes with a respective set of asset data that is related to how assets operate when located in proximity to the node, wherein the respective set of asset data for each of the plurality of nodes comprises a respective value of at least one given asset data variable;
for each of one or more candidate linestrings in the initial dataset, evaluating whether any one or more candidate nodes in the candidate linestring can be eliminated using a divergence function that operates to determine a maximum divergence between (i) one set of values that includes an original value of the given asset data variable for each of the one or more candidate nodes and (ii) another set of values that includes an imputed value of the given asset data variable for each of the one or more candidate nodes;
based on the evaluation, identifying a set of nodes in the initial dataset that can be eliminated;
using the identified set of nodes as a basis to eliminate one or more nodes from the initial dataset and thereby generate a reduced dataset; and
using the reduced dataset to evaluate the operation of assets in the given environment.

16. The method of claim 15, wherein evaluating whether any one or more candidate nodes in the candidate linestring can be eliminated using the divergence function comprises:
identifying a first set of candidate nodes that includes one or more nodes in the candidate linestring to be evaluated for elimination;
identifying a first set of imputation nodes that includes two or more nodes in the candidate linestring to be used to impute a respective value of the given asset data variable for each of the first set of candidate nodes;
using the respective values of the given asset data variable for each of the first set of imputation nodes to assign a respective imputed value of the given asset data variable to each of the first set of candidate nodes;
applying the divergence function to determine a first divergence value that indicates a maximum divergence between (i) one set of values that includes an original value of the given asset data variable for each of the first set of candidate nodes and (ii) another set of values that includes an imputed value of the given asset data variable for each of the first set of candidate nodes;
comparing the first divergence value to a threshold; and
based on the comparison, either (i) determining that all of the first set of candidate nodes can be eliminated if the first divergence value does not exceed the threshold or (ii) evaluating whether less than all of the first set of candidate nodes can be eliminated if the first divergence value does exceed the threshold.

17. The method of claim 16, wherein evaluating whether less than all of the first set of candidate nodes can be eliminated comprises:
identifying a given node in the first set of candidate nodes that is associated with the first divergence value;
breaking the candidate linestring into two segments that intersect at the given node; and
for any segment that has more than two nodes:
identifying a second set of candidate nodes that includes one or more nodes in the segment to be evaluated for elimination;
identifying a second set of imputation nodes that includes two or more nodes in the segment to be used to impute a respective value of the given asset data variable for each of the second set of candidate nodes;
using the respective values of the given asset data variable for each of the second set of imputation nodes to assign a respective imputed value of the given asset data variable to each of the second set of candidate nodes;
applying the divergence function to determine a second divergence value that indicates a maximum divergence between (i) one set of values that includes an original value of the given asset data variable for each of the second set of candidate nodes and (ii) another set of values that includes an imputed value of the given asset data variable for each of the second set of candidate nodes;
comparing the second divergence value to a threshold; and
based on the comparison, either (i) determining that all of the second set of candidate nodes can be eliminated if the second divergence value does not exceed the threshold or (ii) evaluating whether less than all of the second set of candidate nodes can be eliminated if the second divergence value does exceed the threshold.

18. The method of claim 15, wherein the at least one given asset data variable comprises one of (i) a data variable indicating a speed of assets located in proximity to a given node of the plurality of nodes, (ii) a data variable indicating a fuel level of assets located in proximity to the given node of the plurality of nodes, (iii) a data variable indicating a fuel consumption of assets located in proximity to the given node of the plurality of nodes, (iv) a data variable indicating an acceleration measurement of assets located in proximity to the given node of the plurality of nodes, (v) a data variable indicating a payload of assets located in proximity to the given node of the plurality of nodes, (vi) a data variable indicating a gear position of assets located in proximity to the given node of the plurality of nodes, (vii) a data variable indicating a number of gear shifts by assets located in proximity to the given node of the plurality of nodes, (viii) a data variable indicating an ambient temperature in proximity to the given node of the plurality of nodes, or (ix) a data variable indicating a humidity in proximity to the given node of the plurality of nodes.

19. The method of claim 15, the method further comprising, before evaluating whether any one or more candidate nodes in the candidate linestring can be eliminated:
identifying one or more nodes of the initial dataset that are ineligible to be eliminated based on applying one or more threshold criterion; and
defining at least one linestring by removing the identified one or more nodes of the initial dataset that are ineligible to be eliminated, wherein the one or more candidate linestrings in the initial dataset comprises the defined at least one linestring.

20. The method of claim 15, wherein using the reduced dataset to evaluate the operation of assets in the given environment comprises one or more of (i) creating a computer simulation of the operation of assets in the given environment based on the reduced dataset or (ii) executing a computer simulation of the operation of assets in the given environment based on the reduced dataset.
